(19) United States
(12) Patent Application Publication
(10) Pub. No.: US 2025/0246344 A1
(43) Pub. Date: Jul. 31, 2025

(54) GROMMET

(71) Applicant: YAZAKI CORPORATION, Tokyo (JP)

(72) Inventors: Hirotaka Kiyota, Makinohara-shi (JP); Takeshi Onoda, Makinohara-shi (JP); Toshinori Yamada, Makinohara-shi (JP)

(21) Appl. No.: 19/183,719

(22) Filed: Apr. 18, 2025

Related U.S. Application Data
(63) Continuation of application No. PCT/JP2024/008404, filed on Mar. 6, 2024.

(30) Foreign Application Priority Data
Apr. 6, 2023 (JP) 2023-062327

(51) Int. Cl. H01B 17/58

(52) U.S. Cl. CPC H01B 17/583

(57) ABSTRACT

A base member made of a hard resin, and a grommet main body formed by integrally molding a waterproof member made of an elastically deformable soft resin and a support member made of a hard resin and assembled to the base member, are provided, and a plurality of engagement mechanisms for engaging a first engagement portion of the base member with a second engagement portion of the support member and holding the base member and the grommet main body at the assembly completion position are provided around an axis of a cylinder axis of the base member, between the base member and the support member.

### CROSS-REFERENCE TO RELATED APPLICATION(S)

This application is a continuation application of International Application PCT/JP2024/008404, filed on Mar. 6, 2024 which claims the benefit of priority from Japanese Patent Application No. 2023-062327 filed on Apr. 6, 2023 and designating the U.S., the entire contents of which are incorporated herein by reference.

### BACKGROUND OF THE INVENTION

### 1. Field of the Invention

The present invention relates to a grommet.

### 2. Description of the Related Art

Conventionally, in a wire harness, a wiring member such as an electric wire is inserted into a through-hole provided in an insertion object (for example, a panel or the like of a vehicle body in a vehicle), and accordingly, the wiring member is drawn from one space separated by the insertion object to the other space. For this reason, in order to protect the wiring member from the peripheral edge of the through-hole and to prevent liquid from entering the gap between the through-hole and the wiring member, a grommet that closes the gap is attached to the insertion object. For example, the grommet includes: a base member which is made of a hard synthetic resin material, and allows a wiring member to internally pass through between one space and the other space; and an annular grommet main body made of a synthetic resin material having flexibility such as rubber. The grommet is inserted into the through-hole to bring the grommet main body into close contact with the peripheral edge of the through-hole in the insertion object. In this grommet, the base member and the grommet main body are integrally molded by an integral molding method such as two-color molding. This type of grommet is disclosed in, for example, Japanese Patent Application Laid-open No. JP H8-251 769.

Incidentally, in the conventional grommet, when a mold for integrally molding the base member and the grommet main body is removed, it is necessary to suppress deterioration in quality of the flexible grommet main body by reducing a load applied to the grommet main body from the mold. However, in this grommet, in order to allow the wiring member to internally pass through between one space and the other space, the size of the base member becomes larger than that of the grommet main body, and the shape of the base member tends to become complicated. Therefore, depending on the shapes of the base member and the grommet main body, it may be impossible to avoid an excessive load from the mold to the grommet main body. Therefore, in this case, the base member and the grommet main body may be prepared as separate parts, and the base member and the grommet main body may be assembled to reduce the load from the mold when molding the grommet main body. However, in this grommet, it is necessary to maintain the space between the base member and the grommet main body at the assembly completion position.

### SUMMARY OF THE INVENTION

Therefore, an object of the present invention is to provide a grommet capable of ensuring a holding force between two parts.

### Solution to Problem

A grommet according to one aspect of the present invention includes a cylindrical base member which is made of a hard synthetic resin material, and internally inserts a conductive wiring member that passes from one space to the other space through a through-hole of an insertion object; and an annular grommet main body which is coaxially assembled to the base member and is disposed in the one space at an attachment completion position on the peripheral edge portion of the through-hole of the insertion object, wherein the base member includes an annular flange which is disposed in the one space at the attachment completion position and in which an outer peripheral edge portion is disposed to face the annular peripheral edge portion coaxially with a gap, and a cylindrical body that protrudes coaxially from the flange toward the other space and is inserted into the through-hole at the attachment completion position, the grommet main body is a molded article formed by integrally molding an annular waterproof member made of an elastically deformable synthetic resin material softer than the base member, and coaxially brought into close contact with the outer peripheral edge portion of the flange at an assembly completion position with the base member and coaxially brought into close contact with the peripheral edge portion at the attachment completion position, and an annular support member made of a synthetic resin material harder than the waterproof member, a plurality of engagement mechanisms for engaging a first engagement portion provided in the base member with a second engagement portion provided in the support member and holding the base member and the grommet main body at the assembly completion position are provided around an axis of a cylinder axis of the base member, between the base member and the support member, and one of the first engagement portion and the second engagement portion is formed as a hollow shape opened in a direction orthogonal to the cylinder axis, and the other of the first engagement portion and the second engagement portion is formed as a projection shape inserted into the hollow shape from an opening in the orthogonal direction.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating a grommet according to an embodiment before being attached to an insertion object;

FIG. 2 is a perspective view of the grommet according to the embodiment as viewed from another angle;

FIG. 3 is a plan view of the grommet according to the embodiment as viewed from a cylindrical body side;

FIG. 4 is a cross-sectional view taken along line X1-X1 of FIG. 3;

FIG. 5 is a view illustrating a cross section taken along line X2-X2 in FIG. 3 together with an insertion object before attachment;

FIG. 6 is an exploded perspective view illustrating the grommet of the embodiment;

FIG. 7 is an exploded perspective view of the grommet according to the embodiment as viewed from another angle;

FIG. 8 is an exploded perspective view separately illustrating two base members and a grommet main body after assembling the grommet according to the embodiment;

FIG. 9 is an exploded perspective view of a base member and a waterproof member according to the embodiment;

FIG. 10 is an exploded perspective view of the grommet main body according to the embodiment;

FIG. 11 is a partial cross-sectional view illustrating a part of the molding die of the grommet main body according to the embodiment, and illustrates a place where a second engagement portion does not exist;

FIG. 12 is a partial cross-sectional view illustrating a part of the molding die of the grommet main body according to the embodiment, and illustrates a place where the second engagement portion exists;

FIG. 13 is an exploded perspective view separately illustrating two base members and a grommet main body after assembling the grommet according to a first modification example;

FIG. 14 is an exploded perspective view of the grommet of the first modification example when the grommet is divided into two base members and the grommet main body after being assembled and viewed from different angles;

FIG. 15 is a cross-sectional view of the grommet of the first modification example corresponding to the cross section taken along line X2-X2 of FIG. 3;

FIG. 16 is a plan view illustrating the base member of the first modification example;

FIG. 17 is a cross-sectional view taken along line Y-Y of FIG. 16;

FIG. 18 is an exploded perspective view of the grommet main body of the first modification example;

FIG. 19 is a perspective view illustrating a first mold and a second mold of the grommet main body of the first modification example;

FIG. 20 is a perspective view of the first mold and the second mold of the grommet main body of the first modification example as viewed from different angles;

FIG. 21 is a partial cross-sectional view illustrating a part of the molding die of the grommet main body according to the first modification example, and illustrates a place where the second engagement portion does not exist;

FIG. 22 is a partial cross-sectional view illustrating a part of the molding die of the grommet main body according to the first modification example, and illustrates a place where the second engagement portion exists;

FIG. 23 is an exploded perspective view separately illustrating two base members and a grommet main body after assembling the grommet according to a second modification example;

FIG. 24 is an exploded perspective view of the grommet of the second modification example when the grommet is divided into two base members and the grommet main body after being assembled and viewed from different angles; FIG. 25 is a cross-sectional view of the grommet of the second modification example corresponding to the cross section taken along line X2-X2 of FIG. 3;

FIG. 26 is a plan view illustrating the base member of the second modification example;

FIG. 27 is an exploded perspective view of the grommet main body of the second modification example;

FIG. 28 is a partial cross-sectional view illustrating a part of the molding die of the grommet main body according to the second modification example, and illustrates a place where the second engagement portion does not exist;

FIG. 29 is a partial cross-sectional view illustrating a part of the molding die of the grommet main body according to the second modification example, and illustrates a place where the second engagement portion exists;

FIG. 30 is an exploded perspective view separately illustrating two base members and a grommet main body after assembling the grommet according to a third modification example;

FIG. 31 is a cross-sectional view of the grommet of the third modification example corresponding to the cross section taken along line X2-X2 of FIG. 3; and

FIG. 32 is a plan view illustrating the base member of the third modification example.

### DETAILED DESCRIPTION OF THE PREFERRED EMBODIMENTS

Hereinafter, embodiments of a grommet according to the present invention will be described in detail with reference to the drawings. Note that the present invention is not limited by the embodiment.

### Embodiment

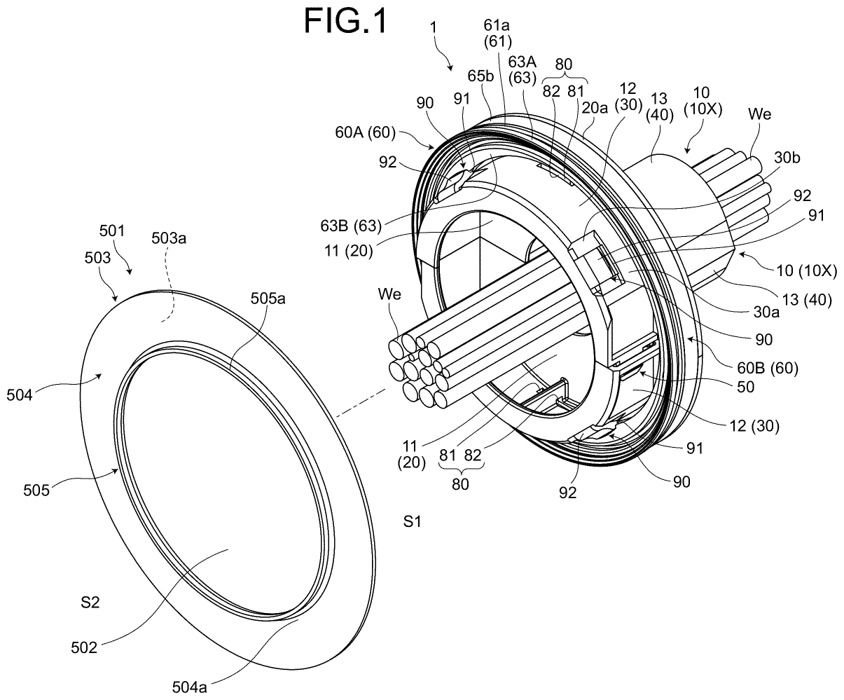

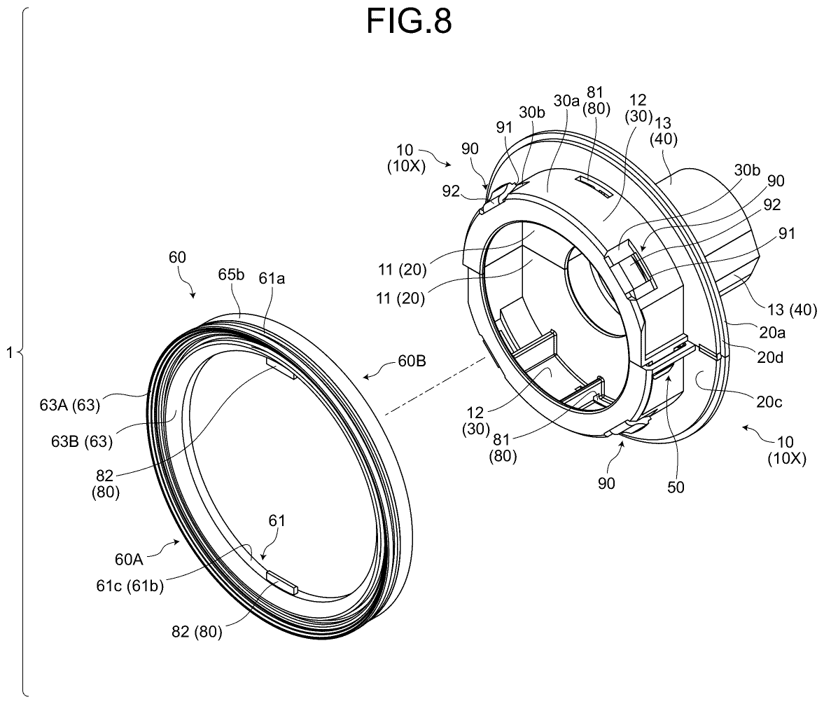

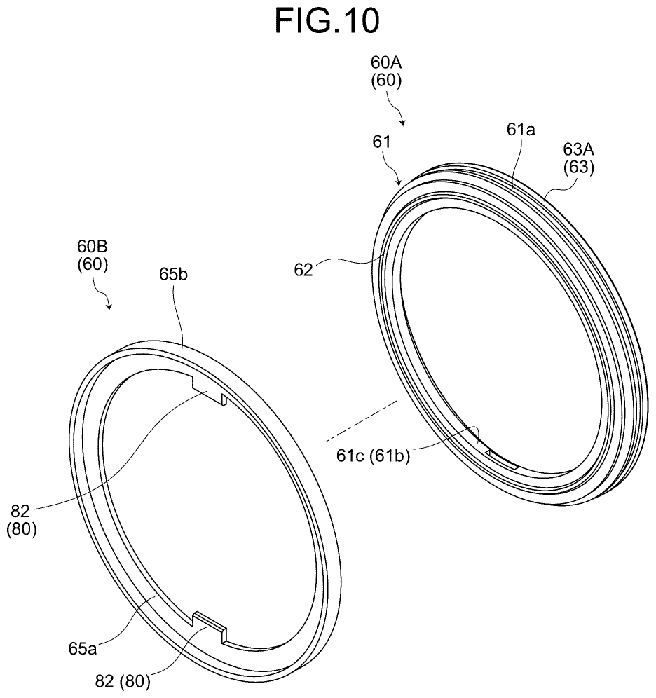

One embodiment of a grommet according to the present invention will be described with reference to FIGS. 1 to 12.

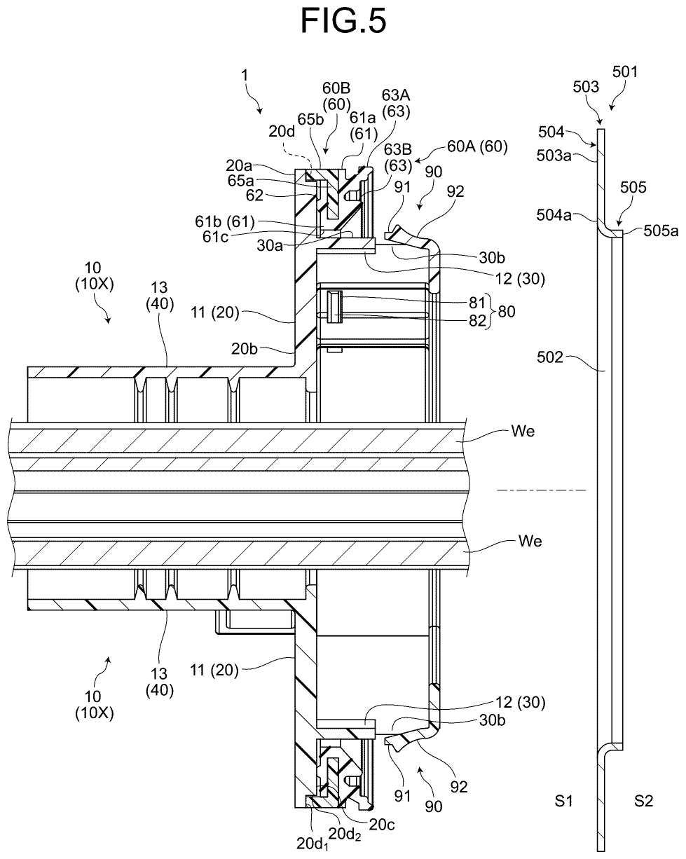

Reference numeral 1 in FIGS. 1 to 8 denotes a grommet according to the present embodiment. The grommet 1 protects a conductive wiring member We, which passes from one space S1 to the other space S2 through a through-hole 502 of an insertion object 501, from a peripheral edge portion 503 of the through-hole 502 in the insertion object 501, and prevents liquid (water or the like) from entering into a gap between the annular peripheral edge portion 503 and the wiring member We (FIGS. 1 and 5). Therefore, the grommet 1 is attached to the peripheral edge portion 503 of the through-hole 502 of the insertion object 501 after the wiring member We is inserted.

Here, the wiring member We is, for example, an electric wire (electric wire as communication wire, electric wire as power supply wire, and the like). In addition, the insertion object 501 is a member for inserting the wiring member We, and indicates, for example, a wall body such as a panel of a vehicle body in the case of a vehicle. The wiring member We is routed between one space S1 and the other space S2 separated by the insertion object 501 by being inserted into the through-hole 502 of the insertion object 501. For example, the wiring member We is responsible for communication between the respective devices in one space S1 and the other space S2, or is responsible for supplying power from a power source of the other space S2 to an electric device in the one space S1.

The peripheral edge portion 503 of the through-hole 502 of the insertion object 501 includes: an annular flat plate portion (hereinafter referred to as an “annular flat plate portion”) 504; and an annular projection portion (hereinafter referred to as an “annular projection portion”) 505 protruding from an end portion of an inner peripheral edge of the annular flat plate portion 504 (inner peripheral edge portion 504a) toward the other space S2 (FIGS. 1 and 5). The grommet 1 is attached to the annular flat plate portion 504 and the annular projection portion 505 at the peripheral edge portion 503. For example, the insertion object 501 is formed by press molding, and the annular flat plate portion 504 and the through-hole 502 are formed at that time. In addition, in the insertion object 501, the annular projection portion 505 is formed by burring the peripheral edge of the through-hole 502. Here, since the through-hole 502 is formed in a round shape, the annular flat plate portion 504 and the annular projection portion 505 are each formed in a circular shape.

The grommet 1 includes a cylindrical base member 10X that allows the wiring member We to be internally inserted (FIGS. 1 to 9). The base member 10X may be formed of one member or may be formed by assembling a plurality of members. The base member 10X illustrated here includes two base members (first base member, second base member) assembled to each other. The two base members may be members having different shapes, or may be the same member having the same shape. In the grommet 1 illustrated here, the same members (base members 10 and 10) having the same shape are used for the two base members (FIGS. 1 to 9).

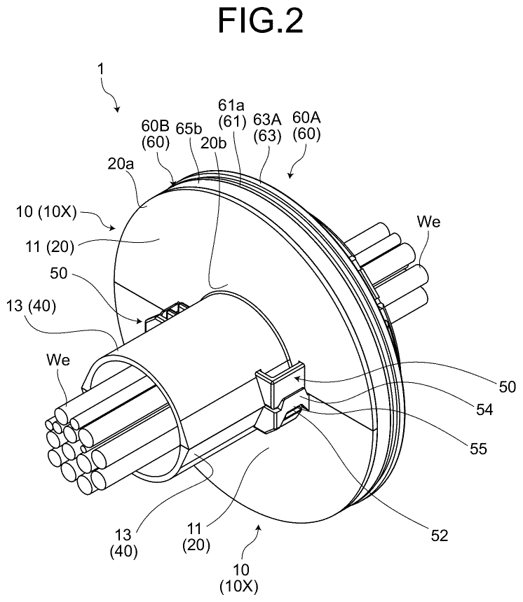

The base member 10X includes at least an annular flange 20 and a cylindrical body 30 coaxially, and allows the wiring member We to be internally inserted thereinto (FIGS. 1 and 2). The base member 10X illustrated here includes, in addition to the flange 20 and the cylindrical body 30, a tubular body 40 coaxially aligned with the flange 20 and the cylindrical body 30, and allows the wiring member We to be internally inserted thereinto (FIGS. 1 and 2). Here, coaxially, the cylindrical body 30 protrudes from the flange 20 toward one side, and the tubular body 40 protrudes from the flange 20 toward the other side.

In the base member 10X illustrated here, as will be described later, the annular flange 20, the cylindrical body 30, and the tubular body 40 are coaxially formed by the base members 10 and 10 assembled to each other. Therefore, a holding mechanism (hereinafter referred to as a “base holding mechanism”) 50 for holding the two base members 10 and 10 in a state of being assembled to each other is provided between the two base members 10 and 10 (FIGS. 1, 2, and 6 to 8).

In addition, the grommet 1 includes an annular grommet main body 60 that is coaxially assembled to the base member 10X (base members 10 and 10 assembled to each other) (FIGS. 1 to 8 and 10). The grommet main body 60 is disposed in the one space S1 at the attachment completion position of the grommet 1 to the peripheral edge portion 503 in order to prevent liquid (water or the like) from entering the other space S2 from the one space S1 through the through-hole 502 (FIGS. 1 and 5). Furthermore, in the following description, the case where simply described as the “attachment completion position” indicates the attachment completion position of the grommet 1 with respect to the peripheral edge portion 503.

The base member 10X (base members 10 and 10) is molded using an insulating hard synthetic resin material (hereinafter referred to as “hard resin”). Here, for example, the base member 10X (base members 10 and 10) is molded using a hard resin such as plastic.

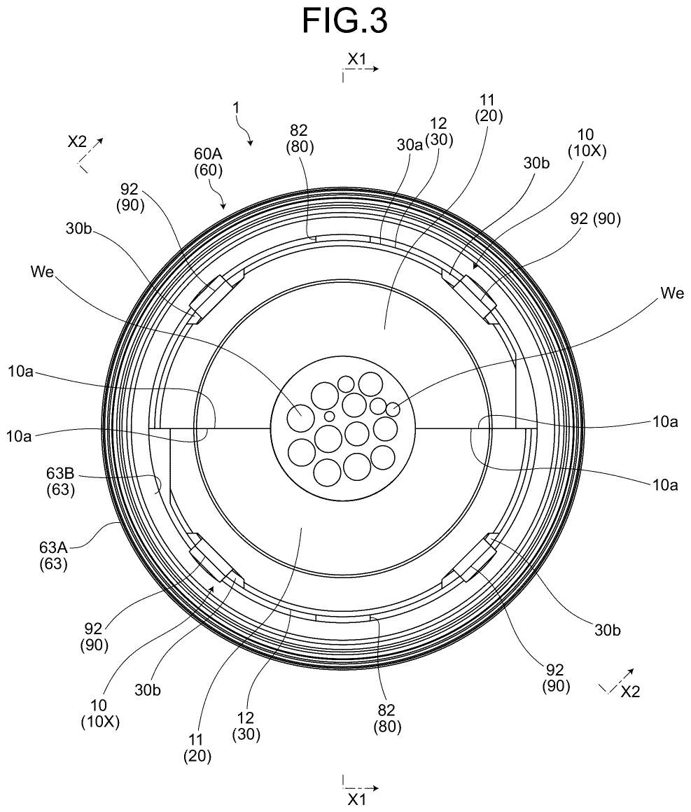

The two base members 10 and 10 are assembled by combining the joint surfaces 10a to each other (FIGS. 3, 6, and 7). The two base members 10 and 10 sandwich the wiring member We in the assembled state, and transition to a state where the wiring member We is inserted therethrough. Here, the annular flange 20, the circular cylindrical body 30, and the tube-like tubular body 40 are formed by assembling the two base members 10 and 10. Furthermore, here, the tubular body 40 of a straight tube is taken as an example. However, the tubular body 40 may be bent after protruding from the flange 20.

The flange 20 is disposed in one space SI at the attachment completion position, with an outer peripheral edge portion 20a disposed to face the peripheral edge portion 503 coaxially with a gap therebetween (FIG. 5). Specifically, in the flange 20, the outer peripheral edge portion 20a is disposed to face an annular flat surface 503a on the one space S1 side in the peripheral edge portion 503 coaxially with a gap therebetween. The annular flat surface 503a is provided on the annular flat plate portion 504. The annular flat surface 503a illustrated here is the annular flat surface itself on the one space S1 side of the annular flat plate portion 504. The flange 20 is formed in an annular plate shape. For example, the flange 20 is formed in a shape similar to the annular flat surface 503a having a circular shape. The circular outer peripheral edge portion 20a of the flange 20 illustrated here is disposed to face the annular flat surface 503a, and allows the wiring member We to be internally inserted into the circular inner peripheral edge portion 20b (FIG. 5). The outer peripheral edge portion 20a is disposed to face the inner peripheral edge portion 504a side of the annular flat plate portion 504 in the annular flat surface 503a coaxially with a gap therebetween in the hole axis direction of the through-hole 502 in one space S1 (FIG. 5).

Each of the two base members 10 and 10 includes a divided flange 11 that combines the joint surfaces 10a to each other to form the flange 20 (FIGS. 1 to 8). The divided flange 11 illustrated here is obtained by dividing the flange 20 in half along the central axis, and is formed in a semicircular arc shape.

The cylindrical body 30 protrudes coaxially from the flange 20 toward the other space S2 and is inserted into the through-hole 502 at the attachment completion position (FIGS. 1 and 5). That is, in the cylindrical body 30, the distal end of the tip protruding from the flange 20 is disposed in the other space S2. The cylindrical body 30 is formed in a cylindrical shape. For example, in the cylindrical body 30, a cross section orthogonal to the hole axis of the through-hole 502 is formed in a shape similar to a cross section orthogonal to the hole axis of the annular projection portion 505. The cylindrical body 30 illustrated here protrudes from the inner peripheral edge portion 20b side rather than the outer peripheral edge portion 20a of the flange 20, and allows the wiring member We to be internally inserted thereinto (FIG. 5).

Each of the two base members 10 and 10 includes a divided cylinder 12 that combines the joint surfaces 10a to each other to form the cylindrical body 30 (FIGS. 1, 3, and 4 to 8). The divided cylinder 12 illustrated here is obtained by dividing the cylindrical body 30 in half along the central axis, and is formed in a semicircular arc shape.

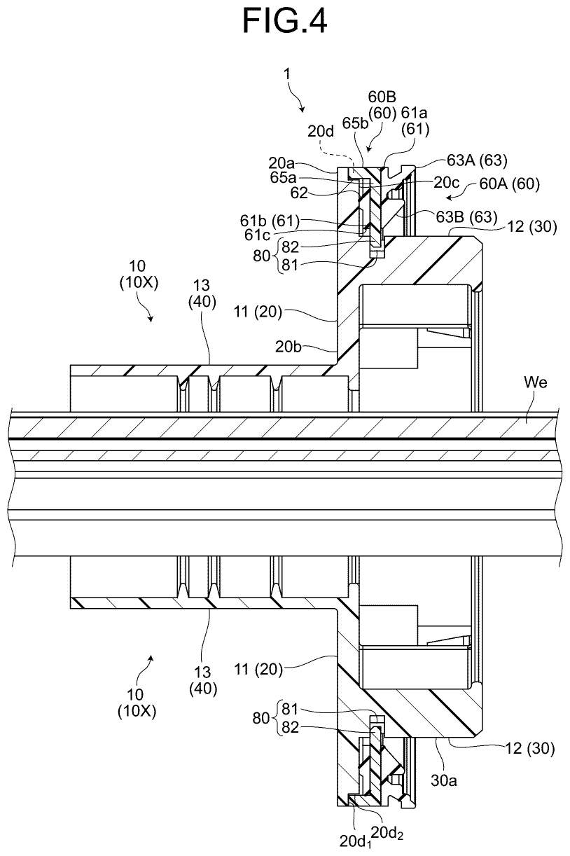

The tubular body 40 protrudes coaxially from the flange 20 in a direction opposite to the cylindrical body 30 (FIGS. 4 and 5). The tubular body 40 is formed in a tube-like shape. For example, in the tubular body 40, a cross section orthogonal to the hole axis of the through-hole 502 is formed in a shape similar to a cross section orthogonal to the hole axis of the annular projection portion 505. The tubular body 40 illustrated here protrudes from the inner peripheral edge portion 20b of the flange 20, and allows the wiring member We to be internally inserted thereinto (FIG. 5).

Each of the two base members 10 and 10 includes a divided tube 13 that combines the joint surfaces 10a to each other to form the tubular body 40 (FIGS. 1, 2, and 4 to 8). The divided tube 13 illustrated here is obtained by dividing the tubular body 40 in half along the central axis, and is formed in a semicircular arc shape.

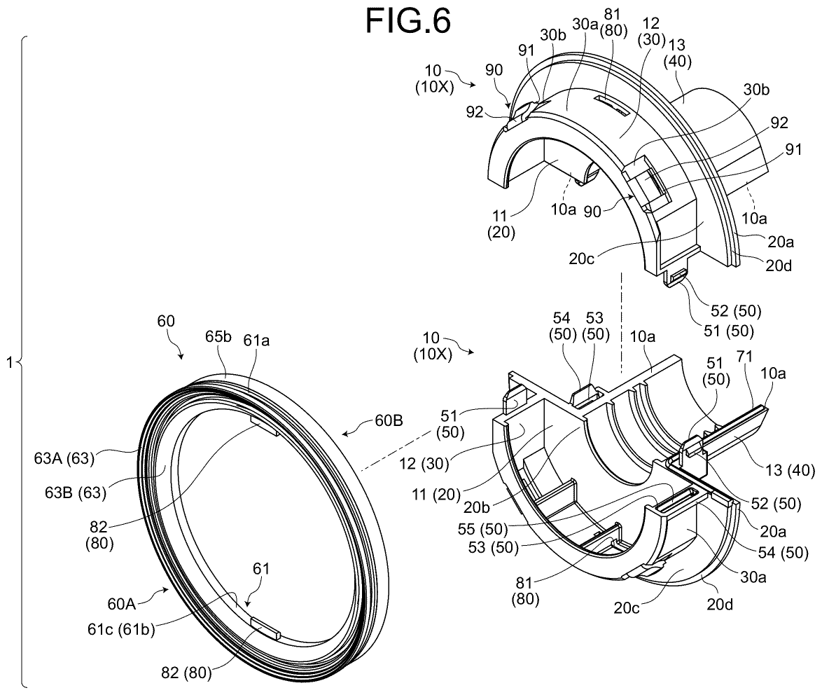

As described above, the two base members 10 and 10 have high hardness such that the main body part (divided flange 11, divided cylinder 12, divided tube 13) is hardly elastically deformed. Therefore, there is a possibility that a minute gap may be formed between the joint surfaces 10a of the two base members 10 and 10 due to, for example, the surface roughness of the joint surfaces 10a. Therefore, the grommet 1 of the present embodiment includes a waterproof member 71 that is made of a synthetic resin material (hereinafter referred to as “soft resin”) softer than the hard resin of the base member 10 and is elastically deformable, and eliminates a gap between the respective joint surfaces 10a, on at least one of the joint surfaces 10a of the respective two base members 10 and 10 (FIGS. 6, 7, and 9).

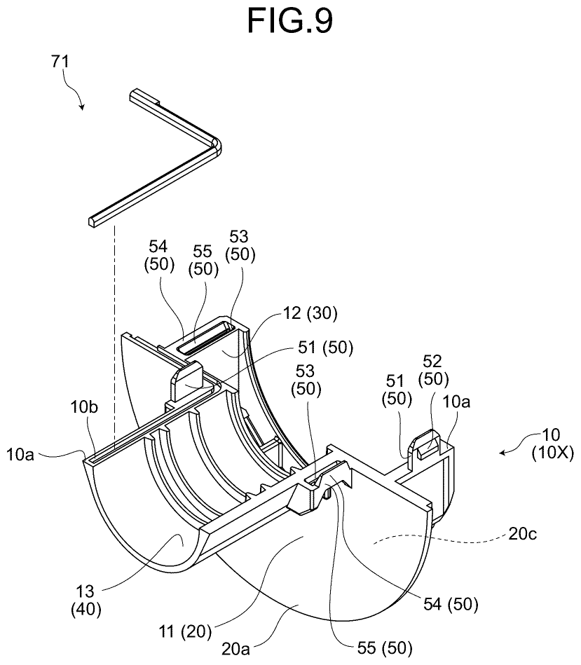

The waterproof member 71 is molded using, for example, a synthetic resin material such as an elastomer. The waterproof member 71 is provided over the joint surfaces 10a of the divided flange 11, the divided cylinder 12, and the divided tube 13, for example. In the base member 10 illustrated here, a groove portion 10b is formed in one of the joint surfaces 10a at two locations from the divided flange 11 to the divided tube 13, and the waterproof member 71 is fitted into the groove portion 10b (FIG. 9). The waterproof member 71 protrudes from the groove portion 10b. For example, the waterproof member 71 is produced by two-color molding with the base member 10, or is insert-molded with respect to the base member 10 housed in a mold, and is integrally molded with respect to the base member 10. In addition, the waterproof member 71 may be molded as a part different from the base member 10, and may be attached to the groove portion 10b of the base member 10 with an adhesive or the like. In the base member 10X, by assembling the two base members 10 and 10, the waterproof member 71 protruding from the groove portion 10b of the one joint surface 10a of the one base member 10 is brought into close contact with the other joint surface 10a of the other base member 10.

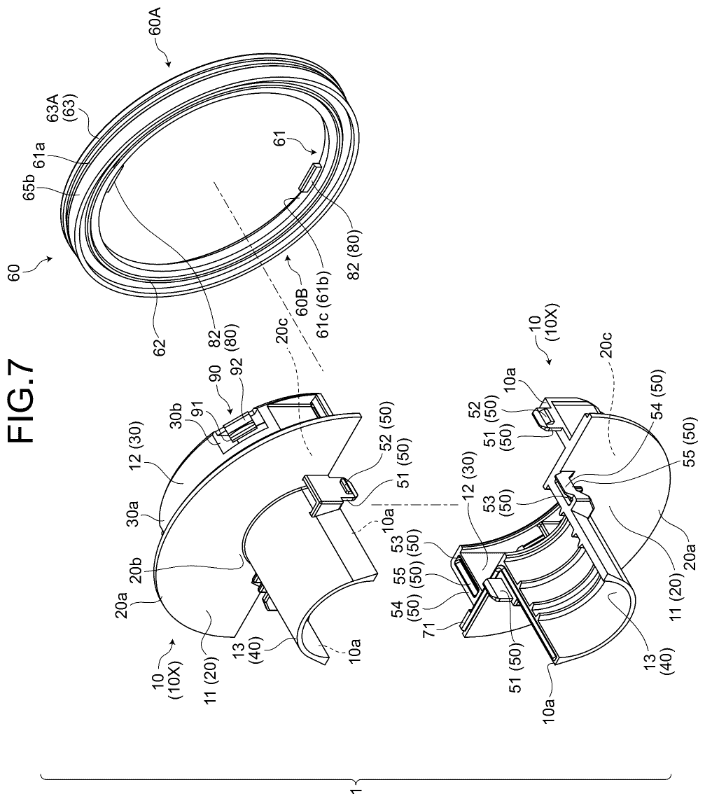

The base holding mechanism 50 is a holding mechanism for holding the two base members 10 and 10 in a state where the respective joint surfaces 10a are kept to be combined to each other. The base holding mechanism 50 is provided at a plurality of locations between the two base members 10 and 10. For example, the base holding mechanism 50 illustrated here includes a piece portion 51 protruding from one joint surface 10a of the two base members 10 and 10, and a claw-like first locking portion 52 protruding from a wall surface of the piece portion 51 (FIGS. 6 and 7). Further, the base holding mechanism 50 illustrated here includes: an insertion port 53 provided in the other joint surface 10a of the two base members 10 and 10 and into which the one piece portion 51 and the first locking portion 52 are inserted; a flexible portion 54 which is provided in the other of the two base members 10 and 10, is bent by being pushed by the first locking portion 52 inserted from the insertion port 53, and eliminates the bending when the first locking portion 52 is separated as the joint surfaces 10a are combined to each other; and a second locking portion 55 provided in the other of the two base members 10 and 10 and disposed to face the first locking portion 52 when the joint surfaces 10a are combined to each other to hold the two base members 10 and 10 in a state where the respective joint surfaces 10a are combined to each other (FIGS. 6 and 7).

Each of the two base members 10 and 10 illustrated here includes one set of the piece portions 51 and the first locking portion 52 at one end in the peripheral direction of the divided cylinder 12, and one set of the insertion ports 53, the flexible portion 54, and the second locking portion 55 at the other end in the peripheral direction of the divided cylinder 12. In the two base members 10 and 10, the first locking portion 52 at one end of the one divided cylinder 12 and the second locking portion 55 at the other end of the other divided cylinder 12 are locked, and the second locking portion 55 at the other end of the one divided cylinder 12 and the first locking portion 52 at one end of the other divided cylinder 12 are locked, in a state where the respective joint surfaces 10a are combined to each other. That is, in the two base members 10 and 10, the base holding mechanisms 50 that connect each of the divided cylinders 12 and hold the divided cylinders 12 in the connected state are provided at two locations. Further, each of the two base members 10 and 10 includes one set of the piece portions 51 and the first locking portion 52 at one end in the peripheral direction of the divided tube 13, and one set of the insertion ports 53, the flexible portion 54, and the second locking portion 55 at the other end in the peripheral direction of the divided tube 13. In the two base members 10 and 10, the first locking portion 52 at one end of the one divided tube 13 and the second locking portion 55 at the other end of the other divided tube 13 are locked, and the second locking portion 55 at the other end of the one divided tube 13 and the first locking portion 52 at one end of the other divided tube 13 are locked, in a state where the respective joint surfaces 10a are combined to each other. That is, in the two base members 10 and 10, the base holding mechanisms 50 that connect each of the divided tubes 13 and hold the divided tubes 13 in the connected state are provided at two locations.

The grommet main body 60 includes: an annular waterproof member 60A made of a soft resin (that is, an elastically deformable synthetic resin material softer than the hard resin of the base member 10X (base member 10)); and an annular support member 60B made of a synthetic resin material harder than the soft resin of the waterproof member 60A and integrated with the waterproof member 60A (FIGS. 1 to 8 and 10). The waterproof member 60A is molded using, for example, a synthetic resin material such as an elastically deformable elastomer softer than the hard resin of the base member 10X (base member 10) or the support member 60B. In addition, the support member 60B is made of, for example, the same hard resin as the base member 10X (base member 10) or a hard resin different from the hard resin having hardness equivalent to the hard resin of the base member 10X (base member 10), and is molded using a synthetic resin material such as plastic.

The grommet main body 60 is configured as a molded article in which the waterproof member 60A and the support member 60B are integrally molded. In the grommet main body 60, the waterproof member 60A is integrated with the support member 60B. For example, the waterproof member 60A is produced by two-color molding with the support member 60B in the mold, or is insert-molded with respect to the support member 60B housed in the mold, and is integrally molded with the support member 60B.

The waterproof member 60A includes an annular main body 61 disposed to face the outer peripheral edge portion 20a of the flange 20 coaxially with a gap therebetween at an assembly completion position with the base member 10X (base members 10 and 10 assembled to each other), and disposed to face the peripheral edge portion 503 coaxially with a gap therebetween at an attachment completion position (FIGS. 1, 2, 4 to 8, and 10). The main body 61 is formed in an annular plate shape. Furthermore, in the following, the case where simply described as the “assembly completion position” indicates the assembly completion position of the base member 10X (base members 10 and 10 assembled to each other) and the grommet main body 60.

The waterproof member 60A is coaxially brought into close contact with the outer peripheral edge portion 20a of the flange 20 at the assembly completion position, and coaxially brought into close contact with the peripheral edge portion 503 at the attachment completion position. The waterproof member 60A includes: an annular first lip 62 that protrudes coaxially from the main body 61, is elastically deformed at the assembly completion position, and is brought into close contact with the outer peripheral edge portion 20a of the flange 20 over the entire periphery; and an annular second lip 63 that protrudes coaxially from the main body 61, is elastically deformed at the attachment completion position, and is brought into close contact with the peripheral edge portion 503 over the entire periphery (FIGS. 1 to 8 and 10).

The main body 61 is disposed face an annular wall surface 20c of the flange 20 on the peripheral edge portion 503 side coaxially with a gap therebetween at the assembly completion position (FIGS. 4 and 5). Then, the first lip 62 is elastically deformed at the assembly completion position to be brought into close contact with the wall surface 20c over the entire periphery coaxially.

In addition, the main body 61 is disposed to face the annular flat surface 503a of the peripheral edge portion 503 coaxially with a gap therebetween at the attachment completion position. Then, the second lip 63 is elastically deformed at the attachment completion position to be brought into close contact with the annular flat surface 503a over the entire periphery coaxially. The waterproof member 60A includes, as the second lip 63, an outer peripheral lip 63A provided on the outer peripheral edge portion 61a side of the main body 61 and coaxial with the main body 61, and an inner peripheral lip 63B provided on the inner peripheral edge portion 61b side of the main body 61 and coaxial with the main body 61 (FIGS. 1, 3 to 6, and 8).

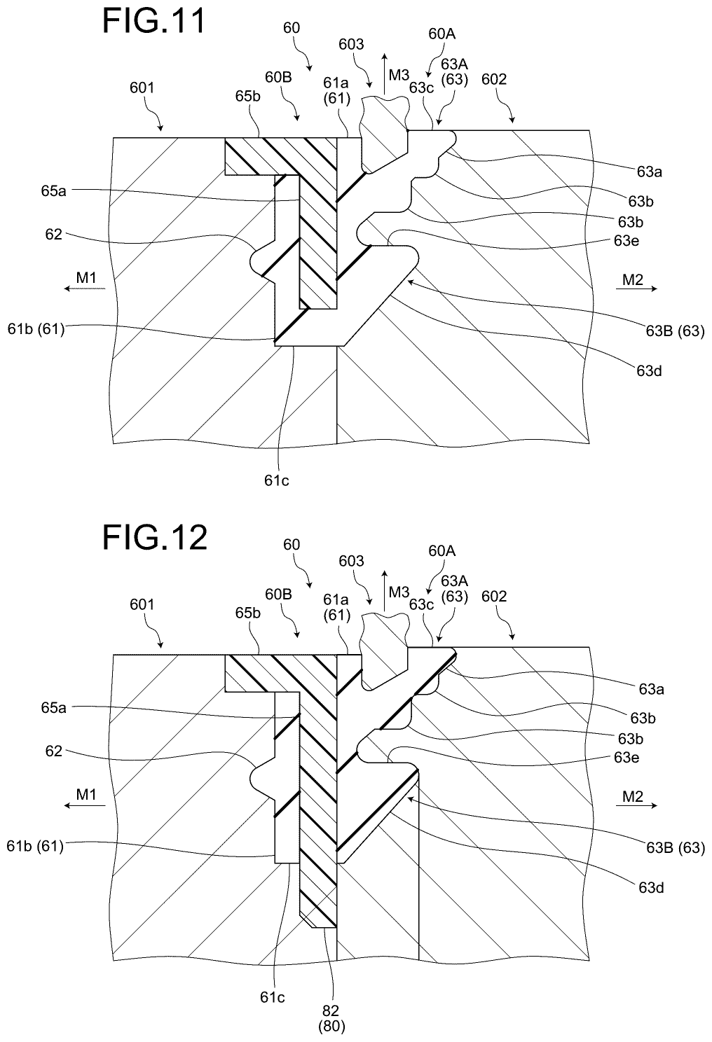

In the waterproof member 60A, the main body 61 and the first lip 62 are formed by a first mold 601, and the second lip 63 (outer peripheral lip 63A, inner peripheral lip 63B) is formed by a second mold 602 (FIG. 11). After molding the waterproof member 60A, the first mold 601 is removed in a removal direction M1 toward one side in the axial direction of the main body 61. In addition, the second mold 602 is removed in a removal direction M2 toward the other side in the axial direction of the main body 61 after molding of the waterproof member 60A.

The first lip 62 is formed in a circular shape that bulges from the main body 61 in the removal direction M1 of the first mold 601 and has an arc-shaped outer wall surface orthogonal to the peripheral direction. As a result, in the waterproof member 60A, the load applied from the first mold 601 can be reduced when the first mold 601 is removed in the removal direction M1.

The outer peripheral lip 63A protrudes to be separated from the axis of the main body 61 (hole axis of the through-hole 502) as the distance from the main body 61 increases in the removal direction M2 of the second mold 602. In addition, the outer peripheral lip 63A includes two annular sub lip portions 63b coaxially protruding from the wall surface 63a in the removal direction M2 of the second mold 602, on the inner wall surface 63a in the radial direction (FIG. 11). The outer peripheral lip 63A is bent and deformed from the base on the main body 61 side at the attachment completion position, and the two sub lip portions 63b are brought into close contact with the annular flat surface 503a of the peripheral edge portion 503. Furthermore, the wall surface 63c on the outer side in the radial direction of the outer peripheral lip 63A is formed by at least two third molds 603 removed in a removal direction M3 toward the outer side in the radial direction. As a result, in the waterproof member 60A, the load applied from the third mold 603 can be reduced when the third mold 603 is removed in the removal direction M3.

In addition, the inner peripheral lip 63B includes: an inner peripheral surface 63d inclined to be more separated from the axis of the main body 61 (hole axis of the through-hole 502) as the distance from the main body 61 increases in the removal direction M2 of the second mold 602; and an outer peripheral surface 63e parallel to the removal direction M2 of the second mold 602 (FIG. 11).

In the waterproof member 60A, the shape of the second lip 63 (outer peripheral lip 63A, inner peripheral lip 63B) can reduce the load applied from the second mold 602 when the second mold 602 is removed in the removal direction M2.

The support member 60B includes an annular portion (hereinafter referred to as a “first annular portion”) 65a disposed to face the outer peripheral edge portion 20a of the flange 20 coaxially with a gap therebetween at the assembly completion position (FIGS. 4, 5, and 10). In addition, the first annular portion 65a is disposed to face the peripheral edge portion 503 coaxially with a gap therebetween at the attachment completion position. The first annular portion 65a illustrated here is disposed to face the wall surface 20c of the flange 20 coaxially with a gap therebetween at the assembly completion position, and is disposed to face the annular flat surface 503a of the peripheral edge portion 503 coaxially with a gap therebetween at the attachment completion position. The first annular portion 65a is formed in an annular plate shape of which the outer diameter is the same as the outer diameter of the flange 20.

In the grommet main body 60, the first annular portion 65a of the support member 60B is integrated with the main body 61 of the waterproof member 60A. In the main body 61 illustrated here, the first annular portion 65a is coaxially integrated in a form fitted into an annular groove having the inner peripheral surface 61c side as a groove bottom and the flange 20 side and the peripheral edge portion 503 side as respective groove side walls (FIG. 5).

Further, the support member 60B includes an annular portion (hereinafter referred to as a “second annular portion”) 65b coaxially protruding from the outer peripheral edge portion of the first annular portion 65a toward the outer peripheral edge portion 20a of the flange 20 (FIGS. 1, 2, 4 to 8, and 10). In addition, the outer peripheral edge portion 20a of the flange 20 includes an annular fitting portion 20d into which the second annular portion 65b is coaxially fitted (FIGS. 4 to 6 and 8). The fitting portion 20d includes: a first wall surface 20d₁ disposed to face the inner peripheral surface of the second annular portion 65b; and a second wall surface 20d₂ disposed to face the annular end surface on the protruding direction side of the second annular portion 65b (FIGS. 4 and 5).

Here, in the support member 60B, the first lip 62 is disposed in a disk-shaped space surrounded by the first annular portion 65a and the second annular portion 65b. Therefore, the flange 20 has a function as a lid that closes the disk-shaped space of the support member 60B at the assembly completion position. In addition, in the grommet main body 60, as described above, the outer diameter of the flange 20 and the outer diameter of the first annular portion 65a are the same, and water is less likely to be splashed into the gap between the second wall surface 20d₂ of the flange 20 and the end surface of the second annular portion 65b. Therefore, in the grommet main body 60, it is possible to prevent water from entering the disk-shaped space of the support member 60B from the gap, and even when water enters the disk-shaped space of the support member 60B from the gap, the water can be stopped by the first lip 62.

Between the base member 10X (base members 10 and 10 assembled to each other) and the support member 60B, a plurality of engagement mechanisms 80 for engaging a first engagement portion 81 provided in the base member 10X (base members 10 and 10 assembled to each other) and a second engagement portion 82 provided in the support member 60B and holding the base member 10X (base members 10 and 10 assembled to each other) and the grommet main body 60 at the assembly completion position are provided around the axis of the cylinder axis of the base member 10X (base members 10 and 10 assembled to each other) (FIGS. 1, 3, 4, 6 to 8, and 10). One of the first engagement portion 81 and the second engagement portion is formed as a hollow shape opened in a direction orthogonal to the cylinder axis of the base member 10X, and the other is formed as a projection shape inserted from the opening into the hollow shape in the direction orthogonal to the cylinder axis of the base member 10X. Here, two engagement mechanisms 80 are provided at equal intervals around the axis of the cylinder axis of the base member 10x, one engagement mechanism 80 is provided in the divided cylinder 12 of one base member 10, and the other engagement mechanism 80 is provided in the divided cylinder 12 of the other base member 10.

In the engagement mechanism 80 of the present embodiment, the first engagement portion 81 of the base member 10X (base members 10 and 10 assembled to each other) is formed in a hollow shape, and the second engagement portion 82 of the support member 60B is formed in a projection shape. Specifically, in the grommet main body 60, the cylindrical body 30 of the base member 10X (base members 10 and 10 assembled to each other), the main body 61 of the waterproof member 60A, and the first annular portion 65a of the support member 60B are concentrically disposed, and the inner peripheral surface 61c of the main body 61 and the inner peripheral surface of the first annular portion 65a are disposed to face the outer peripheral surface 30a of the cylindrical body 30 with a gap therebetween (FIG. 5). Therefore, a first engagement portion 81 having an opening disposed to face the inner peripheral surface 61c of the main body 61 is formed in the cylindrical body 30 (FIGS. 4, 6, and 8). The second engagement portion 82 is formed as a projection shape protruding from the inner peripheral surface of the first annular portion 65a and extending from the inner peripheral surface 61c of the main body 61 (FIGS. 4, 6 to 8, and 10). Here, the first engagement portion 81 is formed as a hollow shape of a through-hole shape having a rectangular opening, and the second engagement portion 82 is formed in a claw-like projection shape.

In the engagement mechanism 80, by assembling the base member 10X (base members 10 and 10 assembled to each other) and the grommet main body 60, the second engagement portion 82 slides on the outer peripheral surface 30a of the cylindrical body 30, and when the base member 10X (base members 10 and 10 assembled to each other) and the grommet main body 60 reach the assembly completion position, the second engagement portion 82 is inserted into the first engagement portion 81 from the opening. As a result, in the grommet 1, the base member 10X (base members 10 and 10 assembled to each other) and the grommet main body 60 are maintained at the assembly completion position.

The grommet 1 configured as described above includes the holding mechanism 90 for holding the base member 10X assembled to each other (base members 10 and 10 assembled to each other) and the grommet main body 60 in the peripheral edge portion 503 of the through-hole 502 in the insertion object 501 (FIGS. 1, 3, and 5 to 8). The holding mechanism 90 illustrated here uses a resilient force accompanying elastic deformation of the second lip 63 (outer peripheral lip 63A, inner peripheral lip 63B) of the waterproof member 60A, and sandwiches the peripheral edge portion 503 between the second lip 63 (outer peripheral lip 63A, inner peripheral lip 63B) and the locking portion 91 (to be described below) provided on the base member 10X (base member 10) to hold the grommet 1 in the peripheral edge portion 503.

The base member 10X includes the locking portion 91 that protrudes from the outer peripheral surface 30a of the cylindrical body 30 in the other space S2 at the attachment completion position and is brought into contact with the peripheral edge portion 503 from the other space S2 side in the other space S2 at the attachment completion position (FIGS. 1 and 5 to 8). The locking portion 91 locks a part of the peripheral edge portion 503 in the peripheral direction. Therefore, the base member 10X includes a plurality of the locking portions 91 in the peripheral direction of the cylindrical body 30. However, in the cylindrical body 30, the locking portion 91 is disposed to be shifted in the peripheral direction with respect to the first engagement portion 81.

In addition, the base member 10X has a cantilever locking piece portion 92 provided with the locking portion 91 at the free end in the other space S2 at the attachment completion position for each locking portion 91 (FIGS. 1, 3, and 5 to 8). The locking piece portion 92 has, as a free end, a tip protruding from the fixed end on the outer peripheral surface 30a side of the cylindrical body 30 to the one space S1 side in the other space S2 at the attachment completion position, and protrudes from the outer peripheral surface 30a of the cylindrical body 30 on the free end side (initial shape). In addition, the locking piece portion 92 is formed to have flexibility that allows bending of being deformation to change the amount of protrusion from the outer peripheral surface 30a on the free end side. The locking piece portion 92 moves back and forth in a cutout portion 30b obtained by cutting out a part of the cylindrical body 30 due to the bending deformation (FIGS. 1, 3, and 5 to 8). A plurality of combinations of the locking portion 91, the locking piece portion 92, and the cutout portion 30b are provided at equal intervals in the peripheral direction with respect to the cylindrical body 30. In the cylindrical body 30 illustrated here, four sets of combinations of the locking portion 91, the locking piece portion 92, and the cutout portion 30b are provided at equal intervals in the peripheral direction. Here, two sets of combinations of the locking portion 91, the locking piece portion 92, and the cutout portion 30b are provided in the divided cylinder 12 of each base member 10.

When the cylindrical body 30 is inserted into the through-hole 502 from the one space S1, the locking piece portion 92 receives a force from the annular projection portion 505 of the peripheral edge portion 503, is bent and deformed from the initial shape toward the cutout portion 30b, passes through the position of the annular projection portion 505, and advances to the tip of the distal end (hereinafter referred to as a “locking end portion”) 505a of the annular projection portion 505 (FIGS. 1 and 5), and starts to return to the initial shape as the force received from the annular projection portion 505 disappears. Therefore, the locking piece portion 92 is disposed at the tip of the locking end portion 505a of the annular projection portion 505 together with the locking portion 91. Meanwhile, when a series of movements of the locking portion 91 and the locking piece portion 92 occurs, the second lip 63 (outer peripheral lip 63A, inner peripheral lip 63B) of the waterproof member 60A abuts on the annular flat surface 503a side of the peripheral edge portion 503 and is bent and deformed. Therefore, when the force for inserting the grommet 1 into the through-hole 502 (so-called insertion force) is released, the grommet 1 moves to return to the one space S1 side by the resilient force accompanying the elastic deformation of the second lip 63 (outer peripheral lip 63A, inner peripheral lip 63B). Accordingly, the locking portion 91 comes into contact with the locking end portion 505a of the annular projection portion 505 and is locked by the locking end portion 505a (FIG. 5). That is, the annular projection portion 505 locks the locking portion 91 at the distal end (locking end portion 505a) of the tip protruding from the annular flat plate portion 504. At the annular locking end portion 505a, the locking portion 91 is locked at each place in the peripheral direction. Therefore, the peripheral edge portion 503 is sandwiched between the second lip 63 (outer peripheral lip 63A, inner peripheral lip 63B) of the waterproof member 60A and the respective locking portions 91 of the base member 10X (base members 10 and 10).

In the grommet 1 of the present embodiment described above, the engagement mechanism 80 is provided between the base member 10X (base members 10 and 10 assembled to each other) made of hard resin and the support member 60B, and it is possible to ensure the holding force between the base member 10X (base members 10 and 10 assembled to each other) and the grommet main body 60. In the grommet main body 60 of the present embodiment, the second engagement portion 82 is provided as a projection shape that is coaxially integrated with the first annular portion 65a in a form of being fitted into an annular groove of the main body 61 having the inner peripheral surface 61c side as a groove bottom, protrudes from the inner peripheral surface of the first annular portion 65a, and extends from the inner peripheral surface 61c of the main body 61. Therefore, here, by forming the first mold 601 and the second mold 602 in a form of avoiding the second engagement portion 82, the first mold 601 can be removed in the removal direction M1 while reducing the load applied to the waterproof member 60A from the first mold 601, and the second mold 602 can be removed in the removal direction M2 while reducing the load applied to the waterproof member 60A from the second mold 602 (FIG. 12). Therefore, in the grommet 1 of the present embodiment, the grommet main body 60 in which deterioration in quality of the waterproof member 60A is suppressed is provided.

### First Modification Example

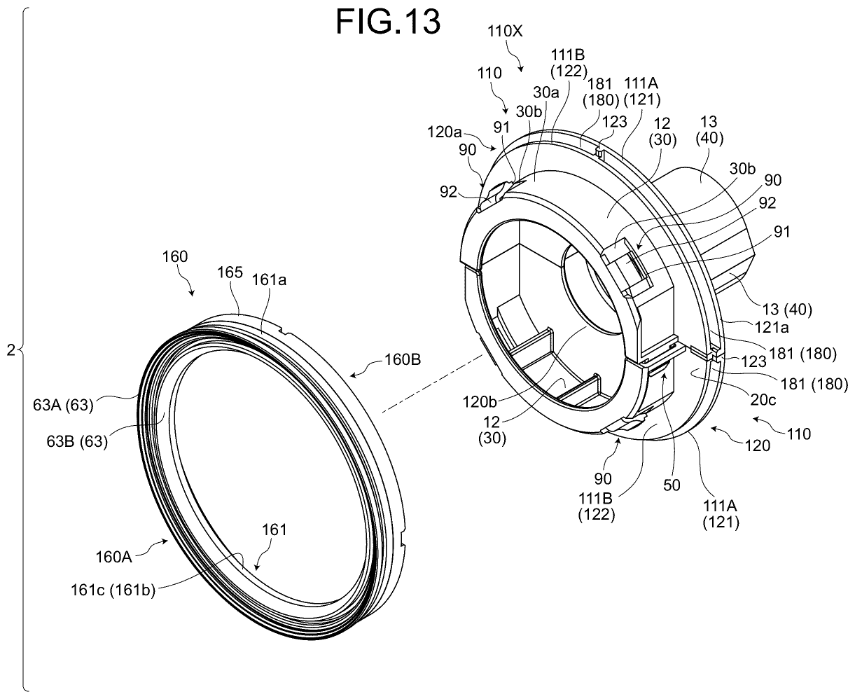

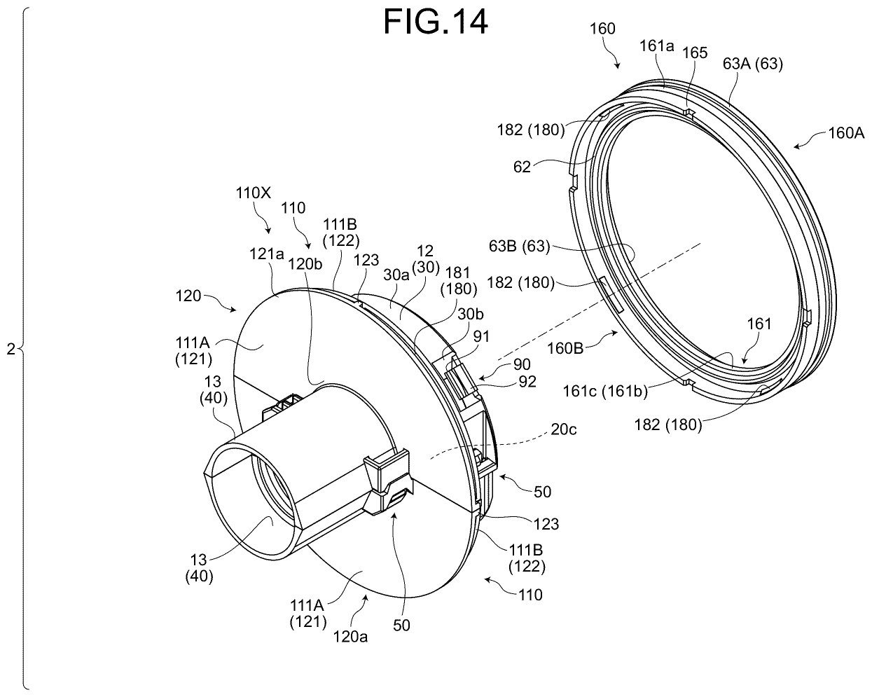

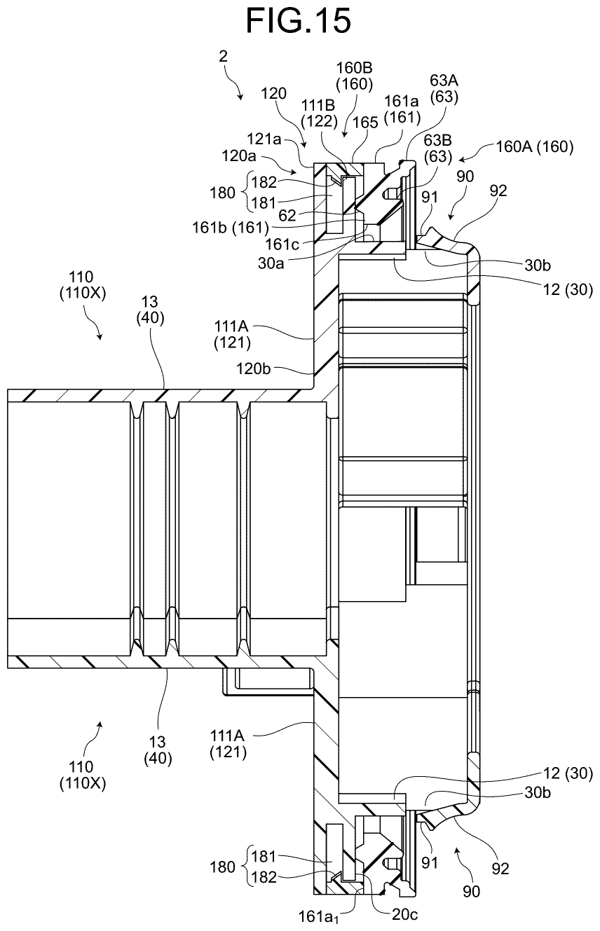

A grommet 2 of the present modification example includes a base member 110X (base members 110 and 110 assembled to each other) and a grommet main body 160 (FIGS. 13 to 15). In addition, the grommet 2 includes an engagement mechanism 180 that engages a first engagement portion 181 provided in the base member 110X (base members 110 and 110 assembled to each other) and a second engagement portion 182 provided in the grommet main body 160, and holds the base member 110X (base members 110 and 110 assembled to each other) and the grommet main body 160 at the assembly completion position, between the base member 110X (base members 110 and 110 assembled to each other) and the grommet main body 160 (FIGS. 13 to 15).

The base member 110X (base members 110 and 110 assembled to each other) is obtained by applying the modifications (to be described below) in the base member 10X (base members 10 and 10 assembled to each other) of the above-described embodiment. In addition, the grommet main body 160 is obtained by applying the modifications (to be described below) in the grommet main body 60 of the above-described embodiment. Therefore, the same reference numerals as those in the embodiment denote the same components, parts, and the like as those in the embodiment also in the description of the present modification example.

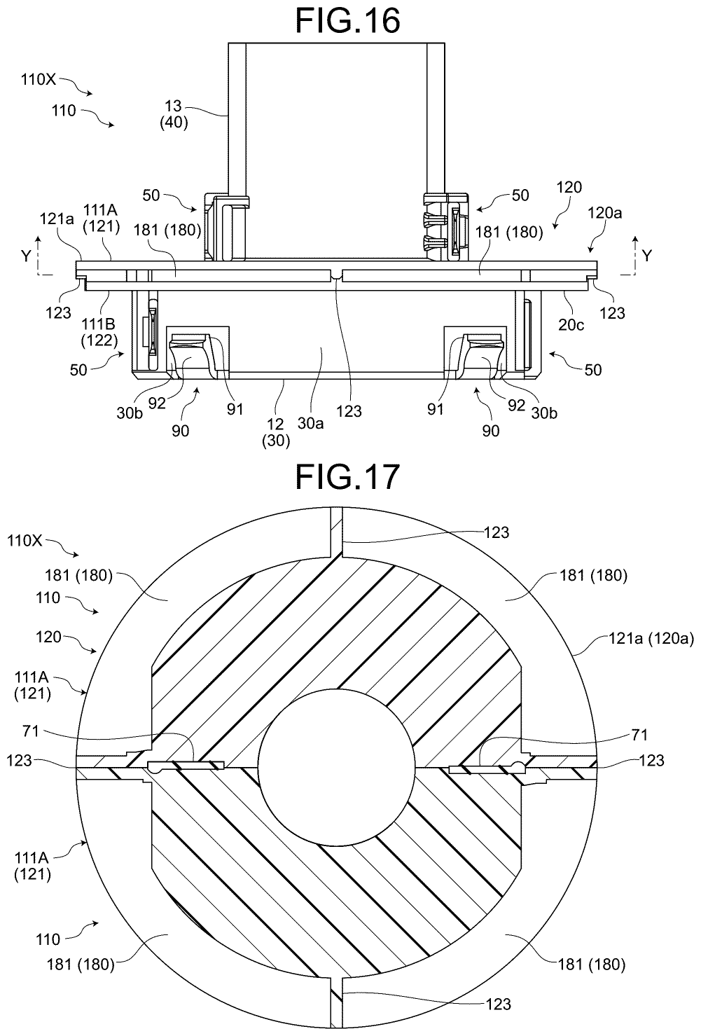

The base member 110X of the present modification example corresponds to the base member 10X of the embodiment in which the flange 20 is replaced with a flange 120 (FIGS. 13 to 17). In the flange 120, similarly to the flange 20 of the embodiment, the outer peripheral edge portion 120a is disposed to face the peripheral edge portion 503 coaxially with a gap therebetween, and the wiring member We is inserted into the inner peripheral edge portion 120b. However, the flange 120 is a part corresponding to the flange 20 of the embodiment, and includes an annular first flange portion 121 in which the outer peripheral edge portion 121a is disposed to face the peripheral edge portion 503 coaxially with a gap therebetween (FIGS. 13 to 17). The flange 120 includes an annular second flange portion 122 which is disposed to face the outer peripheral edge portion 121a between the outer peripheral edge portion 121a of the first flange portion 121 and the peripheral edge portion 503 coaxially with a gap therebetween, and connects the inner peripheral edge portion to the outer peripheral surface 30a of the cylindrical body 30 (FIGS. 13 to 16).

In the flange 120, the outer peripheral edge portion 120a is formed by the outer peripheral edge portion 121a of the first flange portion 121 and the second flange portion 122, and the inner peripheral edge portion of the first flange portion 121 itself becomes the inner peripheral edge portion 120b. In the flange 120, an annular gap having a hollow shape is formed between the first flange portion 121 and the second flange portion 122, and the annular gap opens outward in a direction orthogonal to the cylinder axis of the base member 110X. In the present modification example, an annular gap provided with such an opening is used as the first engagement portion 181 of the engagement mechanism 180. That is, the first engagement portion 181 having such an opening is formed on the outer peripheral edge portion 120a of the flange 120.

Here, the flange 120 includes a plurality of connection portions 123 for connecting the first flange portion 121 and the second flange portion 122 in an annular gap between the first flange portion 121 and the second flange portion 122 (FIGS. 13, 14, 16, and 17). The connection portion 123 is formed in a rib shape extending from the outer peripheral surface 30a of the cylindrical body 30 to the position of the outer peripheral surface of the outer peripheral edge portion 121a of the first flange portion 121 in the direction orthogonal to the cylinder axis of the base member 110X, and a plurality of the connection portions 123 are disposed at intervals around the cylinder axis. Therefore, a plurality of first engagement portions 181 partitioned by the respective connection portions 123 are formed on the outer peripheral edge portion 120a of the flange 120.

The first flange portion 121 illustrated here is formed in an annular plate shape similar to the flange 20 of the embodiment. The second flange portion 122 illustrated here is formed in an annular plate shape having an outer diameter smaller than the outer diameter of the outer peripheral edge portion 121a of the first flange portion 121. In the flange 120, four rib-shaped connection portions 123 are provided at equal intervals around the axis of the cylinder axis of the base member 110X. Therefore, on the outer peripheral edge portion 120a of the flange 120, four first engagement portions 181 are formed at equal intervals around the axis of the cylinder axis.

Each of the two base members 110 and 110 includes: a first divided flange 111A that combines the joint surfaces 10a to each other to form the first flange portion 121; and a second divided flange 111B that combines the joint surfaces 10a to each other to form the second flange portion 122 (FIGS. 13 to 15). The first divided flange 111A and the second divided flange 111B illustrated here are each obtained by dividing the first flange portion 121 and the second flange portion 122 into halves along the central axis, and are formed in a semicircular arc shape.

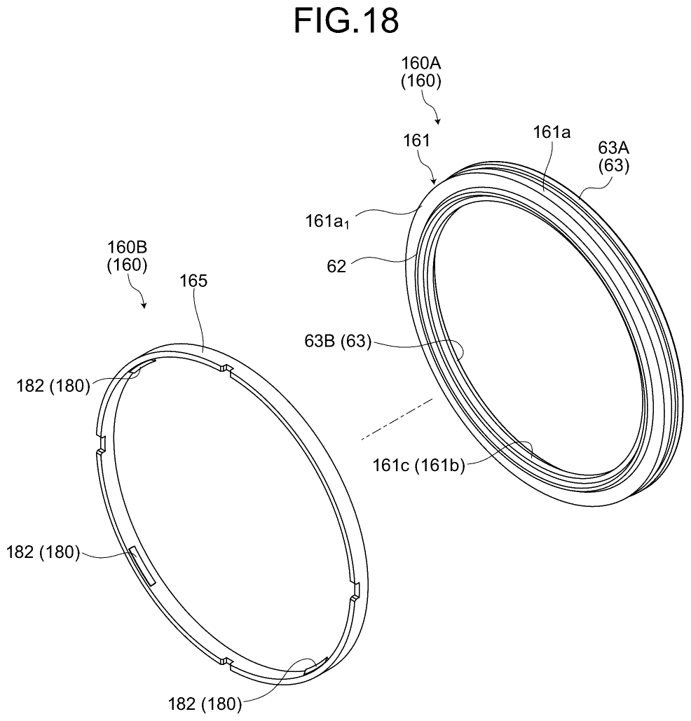

The grommet main body 160 includes an annular waterproof member 160A made of a soft resin, and an annular support member 160B made of a synthetic resin material harder than the soft resin of the waterproof member 160A and integrated with the waterproof member 160A (FIGS. 13 to 15 and 18). Here, the waterproof member 160A and the support member 160B are formed in a circular shape which is the same as in the embodiment.

The waterproof member 160A corresponds to the waterproof member 60A of the embodiment in which the main body 61 is replaced with the main body 161 (FIGS. 13 to 15 and 18). The main body 161 corresponds to an annular groove for the first annular portion 65a and a through-hole for the second engagement portion 82 formed when the main body 61 is integrally molded with the support member 60B.

The support member 160B includes an annular portion 165 that is integrated with an annular joint portion 161a₁ at the outer peripheral edge portion 161a of the main body 161 and coaxially protrudes from the joint portion 161a₁ toward the outer peripheral edge portion 120a of the flange 120 (FIGS. 13 to 15 and 18). The annular portion 165 protrudes to a position beyond the second flange portion 122 to reach the outer peripheral edge portion 121a of the first flange portion 121, and closes an annular gap (that is, the first engagement portion 181 of the engagement mechanism 180) between the first flange portion 121 and the second flange portion 122. Therefore, the inner peripheral surface of the annular portion 165 is disposed to face the opening of the first engagement portion 181 at the assembly completion position. Therefore, the second engagement portion 182 of the engagement mechanism 180 is formed as a claw-like projection shape protruding from the inner peripheral surface of the annular portion 165. On the inner peripheral surface of the annular portion 165, a second engagement portion 182 is formed for each of the first engagement portions 181 spaced apart from each other around the axis thereof. Here, four second engagement portions 182 are formed at equal intervals around the axis.

In the engagement mechanism 180 of the present modification example, when the base member 110X (base members 110 and 110 assembled to each other) and the grommet main body 160 are assembled and reach the assembly completion position, the second engagement portion 182 is inserted into the first engagement portion 181 from the opening. The second engagement portion 182 is locked to the second flange portion 122 at the first engagement portion 181. As a result, in the grommet 2, the base member 110X (base members 110 and 110 assembled to each other) and the grommet main body 160 are maintained at the assembly completion position.

Here, in the support member 160B, the first lip 62 is disposed in a disk-shaped space surrounded by the annular portion 165. Therefore, the flange 120 has a function as a lid that closes the disk-shaped space of the support member 160B at the assembly completion position. In the grommet main body 160, the outer diameter of the outer peripheral edge portion 121a of the first flange portion 121 in the flange 120 and the outer diameter of the annular portion 165 are the same, and water is less likely to be splashed into the gap between the outer peripheral edge portion 121a of the first flange portion 121 and the annular portion 165. Therefore, in the grommet main body 160, it is possible to prevent water from entering the disk-shaped space of the support member 160B from the gap, and even when water enters the disk-shaped space of the support member 160B from the gap, the water can be stopped by the first lip 62.

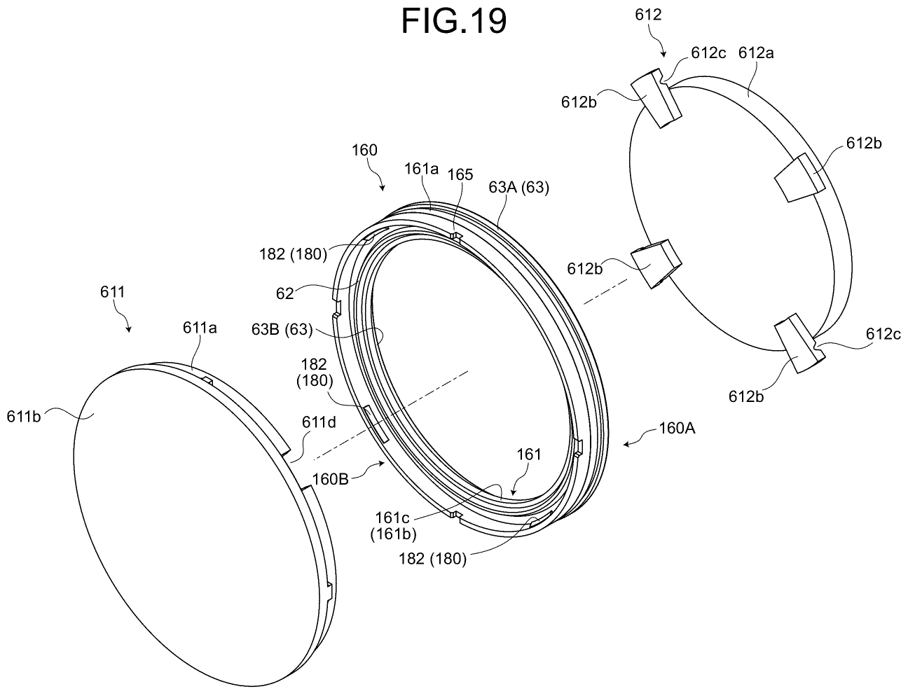

In the grommet main body 160, the main body 161 and the first lip 62 of the waterproof member 160A are formed by a first mold 611 and a second mold 612, and the second lip 63 (outer peripheral lip 63A, inner peripheral lip 63B) of the waterproof member 160A is formed by a third mold 613 and a fourth mold 614 (FIGS. 19 to 22). In the grommet main body 160, the support member 160B is formed by the first mold 611 and the second mold 612 (FIGS. 19 to 22). After molding the waterproof member 160A and the support member 160B, the first mold 611 is removed in the removal direction M1 toward one side in the axial direction of the main body 161. In addition, the second mold 612 and the third mold 613 are removed in the removal directions M2 and M3 toward the other side in the axial direction of the main body 161 after molding of the waterproof member 160A and the support member 160B. The fourth mold 614 corresponds to the third mold 603 described in the embodiment, and at least two of the fourth molds 614 are provided and removed in a removal direction M4 directed outward in the radial direction.

The first mold 611 and the second mold 612 are divided in the peripheral direction into a first region where the claw-like second engagement portion 182 is not present and a second region where the claw-like second engagement portion 182 is present to form the main body 161, the first lip 62, and the support member 160B of the waterproof member 160A. However, an inner peripheral surface 161c of the inner peripheral edge portion 161b of the main body 161 is formed by the outer peripheral surface of a disk portion 612a of the second mold 612 (FIGS. 19, 21, and 22).

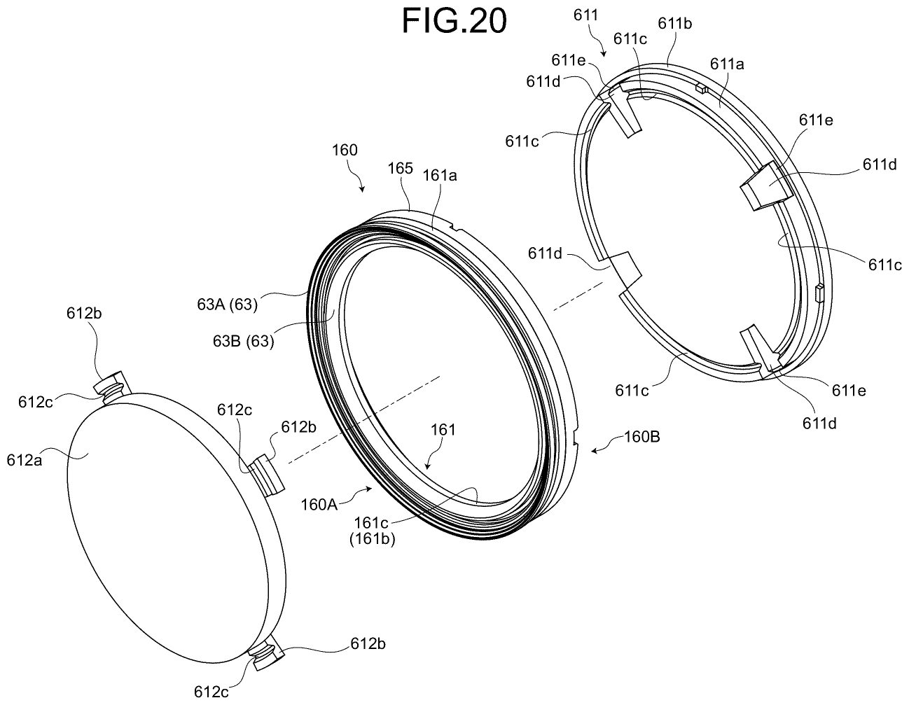

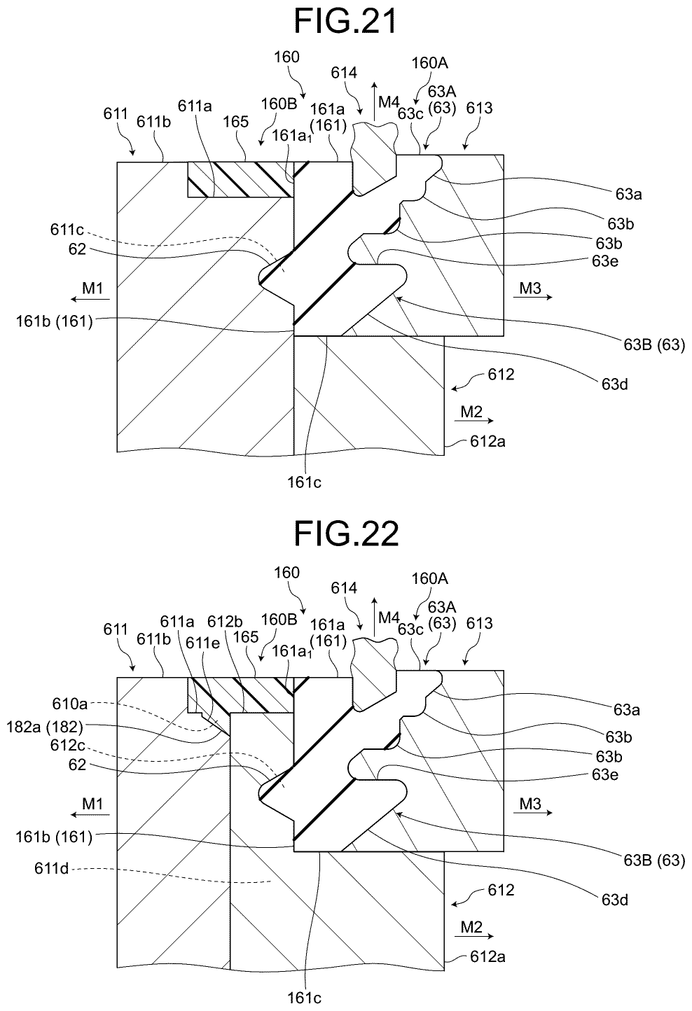

In the first region occupying most of the main body 161, the first lip 62, and the support member 160B, the first lip 62 side of the main body 161 and the first lip 62 are formed by a first disk portion 611a of the first mold 611 (FIGS. 19 and 21). The annular portion 165 of the support member 160B in the first region is formed by the first disk portion 611a and a second disk portion 611b of the first mold 611 (FIGS. 19 and 21). The first disk portion 611a is provided with a groove portion 611c for forming the first lip 62 of the first region (FIGS. 20 and 21).

The first lip 62 side of the main body 161 and the first lip 62 in the second region are formed by a projection portion 612b of the second mold 612 (FIGS. 19, 20, and 22). The projection portion 612b protrudes from the disk portion 612a toward the first mold 611 and protrudes outward in the radial direction from the outer peripheral surface of the disk portion 612a, and is provided for each second engagement portion 182. The projection portion 612b is provided with a groove portion 612c for forming the first lip 62 of the second region (FIGS. 19, 20, and 22).

A groove portion 611d into which the projection portion 612b is fitted is formed in the first disk portion 611a of the first mold 611 (FIGS. 19, 20, and 22). The first disk portion 611a is provided with a wall surface 611e which is a wall surface connected to the groove bottom of the groove portion 611d, forms an inclined surface 182a of the claw-like second engagement portion 182, and forms a space portion 610a for forming the second engagement portion 182 with the projection portion 612b (FIGS. 20 and 22). Therefore, in the support member 160B of the second region, the main body 161 side from the second engagement portion 182 is formed by the projection portion 612b of the second mold 612 on the inner peripheral surface of the annular portion 165, and the remainder of the inner peripheral surface of the annular portion 165 is formed by the first disk portion 611a of the first mold 611.

In the waterproof member 160A, the load applied from the first mold 611 can be reduced when the first mold 611 is removed in the removal direction M1. In addition, in the waterproof member 160A, when the second mold 612 is removed in the removal direction M2, there is a concern about the presence of the projection portion 612b protruding outward in the radial direction from the outer peripheral surface of the disk portion 612a. However, since the region where the projection portion 612b is present is limited to only the second region where the second engagement portion 182 is present and is reduced as much as possible, the load applied from the second mold 612 can be reduced. In addition, in the waterproof member 160A, the load applied from the third mold 613 can be reduced when the third mold 613 is removed in the removal direction M3. In addition, in the waterproof member 160A, the load applied from the fourth mold 614 can also be reduced when the fourth mold 614 is removed in the removal direction M4.

As described above, in the grommet 2 of the present modification example, similarly to the grommet 1 of the embodiment, the engagement mechanism 180 is provided between the base member 110X (base members 110 and 110 assembled to each other) made of hard resin and the support member 160B, and it is possible to ensure the holding force between the base member 110X (base members 110 and 110 assembled to each other) and the grommet main body 160. In the grommet main body 160 of the present modification example, the first mold 611, the second mold 612, the third mold 613, and the fourth mold 614 can be removed in the removal directions M1, M2, M3, and M4, respectively, while reducing the load applied to the waterproof member 160A from the first mold 611, the second mold 612, the third mold 613, and the fourth mold 614 (FIGS. 21 and 22). Therefore, in the grommet 2 of the present modification example, the grommet main body 160 in which deterioration in quality of the waterproof member 160A is suppressed is provided.

### Second Modification Example

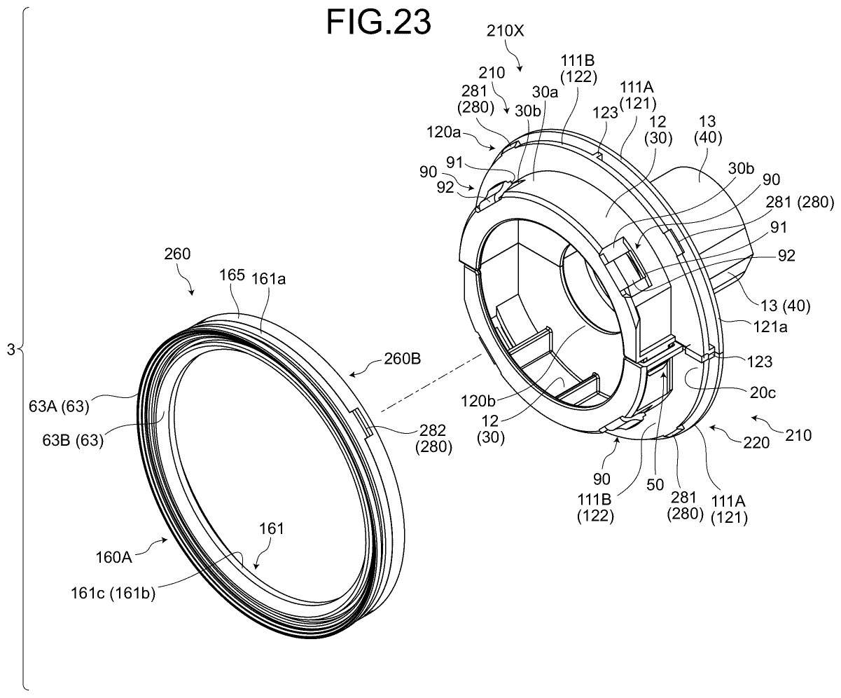

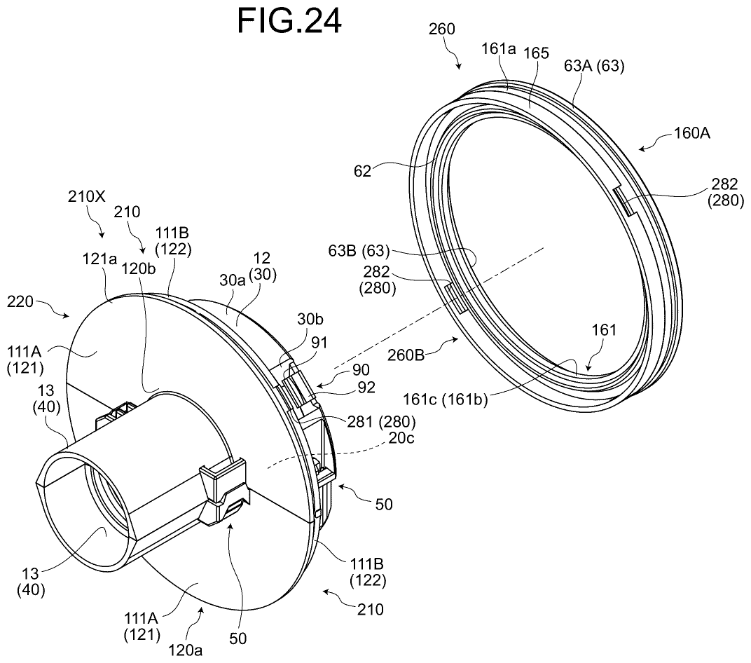

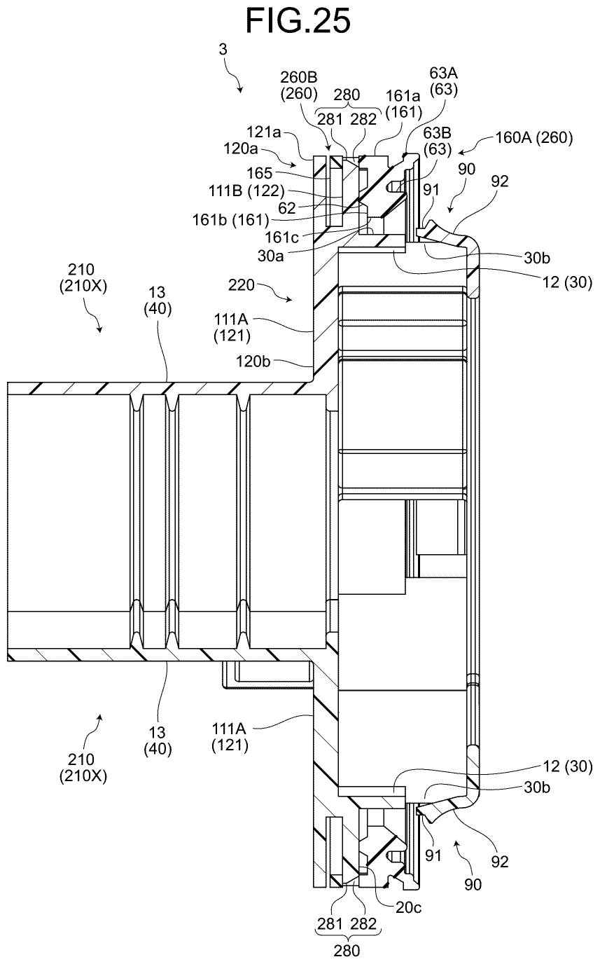

A grommet 3 of the present modification example includes a base member 210X (base members 210 and 210 assembled to each other) and a grommet main body 260 (FIGS. 23 to 25). In addition, the grommet 3 includes an engagement mechanism 280 that engages a first engagement portion 281 provided in the base member 210X (base members 210 and 210 assembled to each other) and a second engagement portion 282 provided in the grommet main body 260, and holds the base member 210X (base members 210 and 210 assembled to each other) and the grommet main body 260 at the assembly completion position, between the base member 210X (base members 210 and 210 assembled to each other) and the grommet main body 260 (FIGS. 23 to 25).

The base member 210X (base members 210 and 210 assembled to each other) is obtained by applying the modifications (to be described below) in the base member 110X (base members 110 and 110 assembled to each other) of the above-described first modification example. In addition, the grommet main body 260 is obtained by applying the modifications (to be described below) in the grommet main body 160 of the above-described first modification example. Therefore, the same reference numerals as those in the embodiment or first modification example denote the same components, parts, and the like as those in the embodiment or first modification example also in the description of the present modification example.

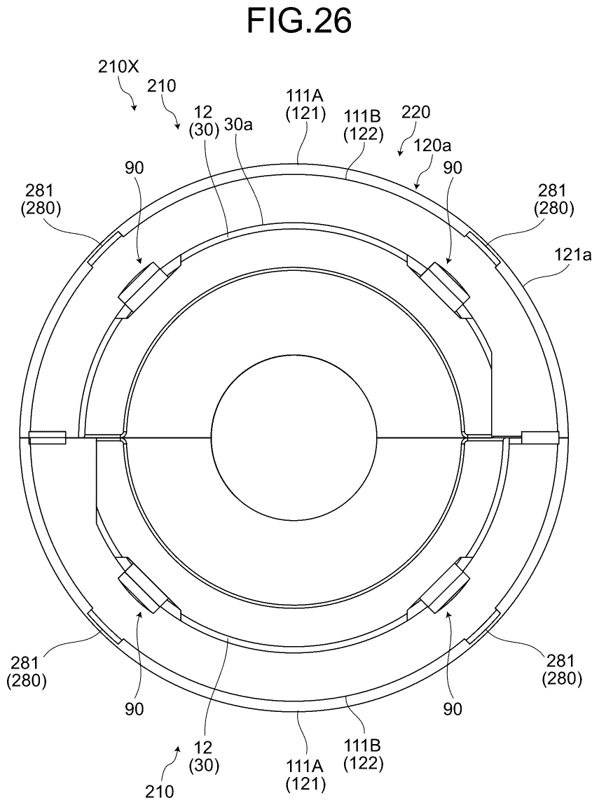

The base member 210X of the present modification example corresponds to the base member 110X of the first modification example in which the flange 120 is replaced with a flange 220 (FIGS. 23 to 26). The flange 220 corresponds to the flange 120 of the first modification example provided with the first engagement portion 281 having a projection shape in the engagement mechanism 280. That is, the flange 220 not only includes the first flange portion 121, the second flange portion 122, and the connection portion 123 similar to those of the flange 120 of the first modification example, but also further includes the first engagement portion 281 having a projection shape. Therefore, in the base member 210X, unlike the base member 110X of the first modification example, the annular gap between the first flange portion 121 and the second flange portion 122 is not used for the engagement mechanism 280.

The first engagement portion 281 is formed in a claw-like projection shape and is provided on the outer peripheral edge portion 120a of the flange 220 (FIGS. 23 to 26). Here, the first engagement portion 281 protrudes from the outer peripheral surface of the second flange portion 122 in the direction orthogonal to the cylinder axis of the base member 210X. On the outer peripheral surface of the second flange portion 122, four first engagement portions 281 are provided at equal intervals around the axis of the cylinder axis.

Furthermore, in the base member 210x, the rib-shaped connection portion 123 extends from the outer peripheral surface 30a of the cylindrical body 30 to the position of the outer peripheral surface of the second flange portion 122 in the direction orthogonal to the cylinder axis of the base member 210X.

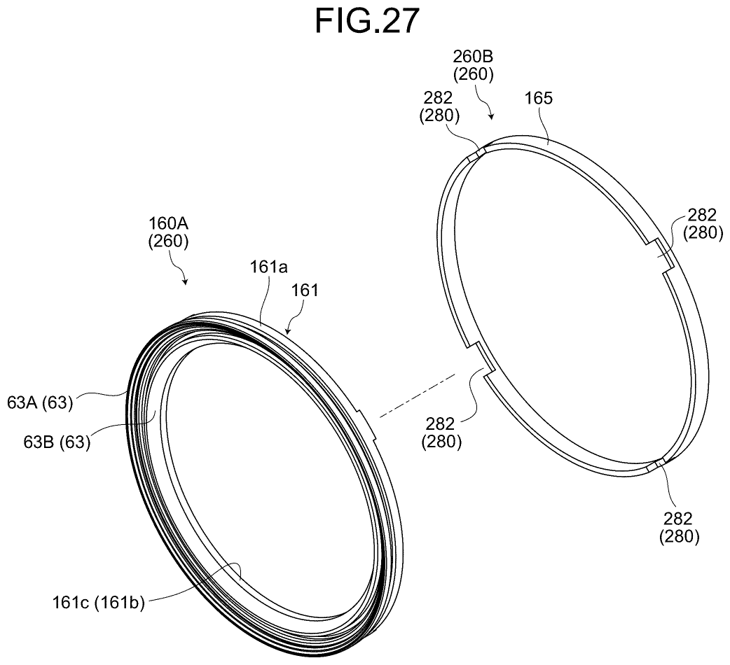

The grommet main body 260 corresponds to the grommet main body 160 of the first modification example in which the support member 160B is replaced with a support member 260B (FIGS. 23 to 25 and 27). The support member 260B corresponds to the support member 160B of the first modification example in which the second engagement portion 182 having a projection shape is removed from the inner peripheral surface of the annular portion 165, and the second engagement portion 282 having a hollow shape in the engagement mechanism 280 is provided in the annular portion 165. That is, the grommet main body 260 is formed by integrating the waterproof member 160A and the support member 260B similar to the grommet main body 160 of the first modification example.

Here, the inner peripheral surface of the annular portion 165 is disposed to face the outer peripheral surface of the second flange portion 122 concentrically at the assembly completion position. Therefore, the second engagement portion 282 is formed between the annular portion 165 and the main body 161 of the waterproof member 160A as a hollow shape of a through-hole shape having a rectangular opening on the inner peripheral surface of the annular portion 165. The second engagement portion 282 is provided for each first engagement portion 281. Therefore, four second engagement portions 282 illustrated here are formed at equal intervals in the peripheral direction of the annular portion 165.

In the engagement mechanism 280 of the present modification example, when the base member 210X (base members 210 and 210 assembled to each other) and the grommet main body 260 are assembled and reach the assembly completion position, the first engagement portion 281 is inserted into the second engagement portion 282 from the opening. The first engagement portion 281 is locked to the annular portion 165 of the support member 260B at the second engagement portion 282. As a result, in the grommet 3, the base member 210X (base members 210 and 210 assembled to each other) and the grommet main body 260 are maintained at the assembly completion position.

Here, in the support member 260B, the first lip 62 is disposed in a disk-shaped space surrounded by the annular portion 165, similarly to the support member 160B of the first modification example. Therefore, the flange 220 has a function as a lid that closes the disk-shaped space of the support member 260B at the assembly completion position. In the grommet main body 260, similarly to the grommet main body 160 of the first modification example, the outer diameter of the outer peripheral edge portion 121a of the first flange portion 121 in the flange 220 and the outer diameter of the annular portion 165 are the same, and water is less likely to be splashed into the gap between the outer peripheral edge portion 121a of the first flange portion 121 and the annular portion 165. Therefore, in the grommet main body 260, it is possible to prevent water from entering the disk-shaped space of the support member 260B from the gap, and even when water enters the disk-shaped space of the support member 260B from the gap, the water can be stopped by the first lip 62.

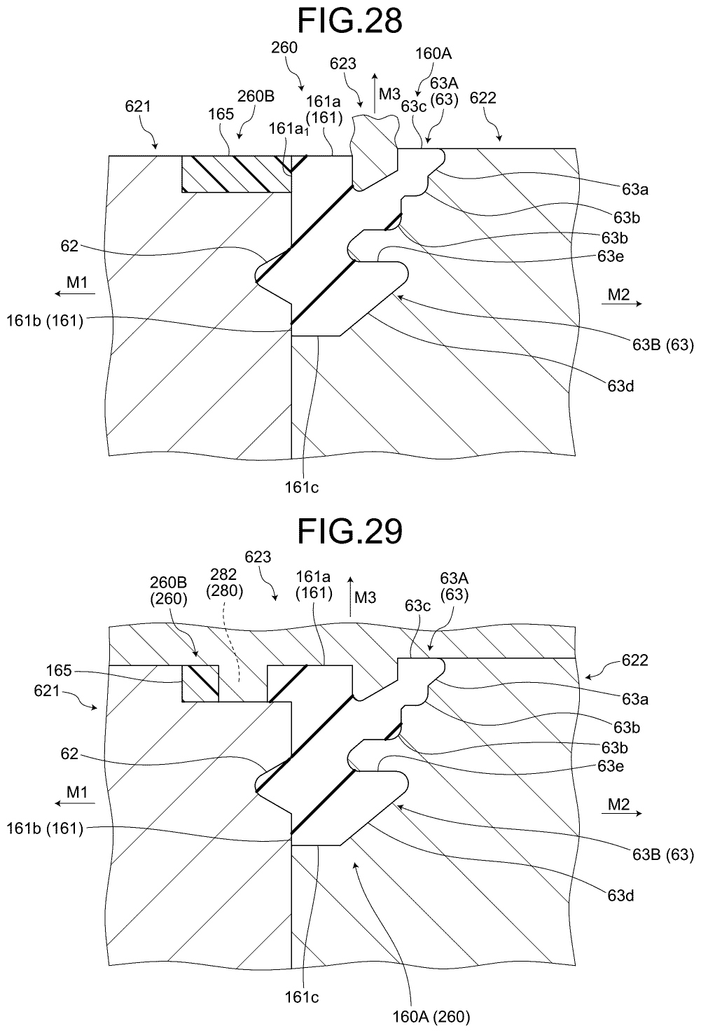

In the grommet main body 260, the waterproof member 160A and the support member 260B are formed by the first mold 621, the second mold 622, and the third mold 623 (FIGS. 28 and 29). After molding the waterproof member 160A and the support member 260B, the first mold 621 is removed in the removal direction M1 toward one side in the axial direction of the main body 161. In addition, the second mold 622 is removed in the removal direction M2 toward the other side in the axial direction of the main body 161 after molding of the waterproof member 160A and the support member 260B. The third mold 623 corresponds to the third mold 603 described in the embodiment, and at least two of the third molds 623 are provided and removed in the removal direction M3 directed outward in the radial direction.

Here, the first lip 62 is formed by the first mold 621, and the second lip 63 (outer peripheral lip 63A, inner peripheral lip 63B) is formed by the second mold 622 (FIGS. 28 and 29). Similarly to the third mold 603 of the embodiment, the third mold 623 forms the wall surface 63c on the outer side in the radial direction of the outer peripheral lip 63A, and forms the second engagement portion 282 having a hollow shape (FIGS. 28 and 29).

In the waterproof member 160A, the load applied from the first mold 621 can be reduced when the first mold 621 is removed in the removal direction M1. In addition, in the waterproof member 160A, the load applied from the second mold 622 can be reduced when the second mold 622 is removed in the removal direction M2. In addition, in the waterproof member 160A, the load applied from the third mold 623 can also be reduced when the third mold 623 is removed in the removal direction M3.

As described above, in the grommet 3 of the present modification example, similarly to the grommet 2 of the first modification example, the engagement mechanism 280 is provided between the base member 210X (base members 210 and 210 assembled to each other) made of hard resin and the support member 260B, and it is possible to ensure the holding force between the base member 210X (base members 210 and 210 assembled to each other) and the grommet main body 260. In the grommet main body 260 of the present modification example, the first mold 621, the second mold 622, and the third mold 623 can be removed in the removal directions M1, M2, and M3, respectively, while reducing the load applied to the waterproof member 160A from the first mold 621, the second mold 622, and the third mold 623 (FIGS. 28 and 29). Therefore, in the grommet 3 of the present modification example, the grommet main body 260 in which deterioration in quality of the waterproof member 160A is suppressed is provided.

### Third Modification Example

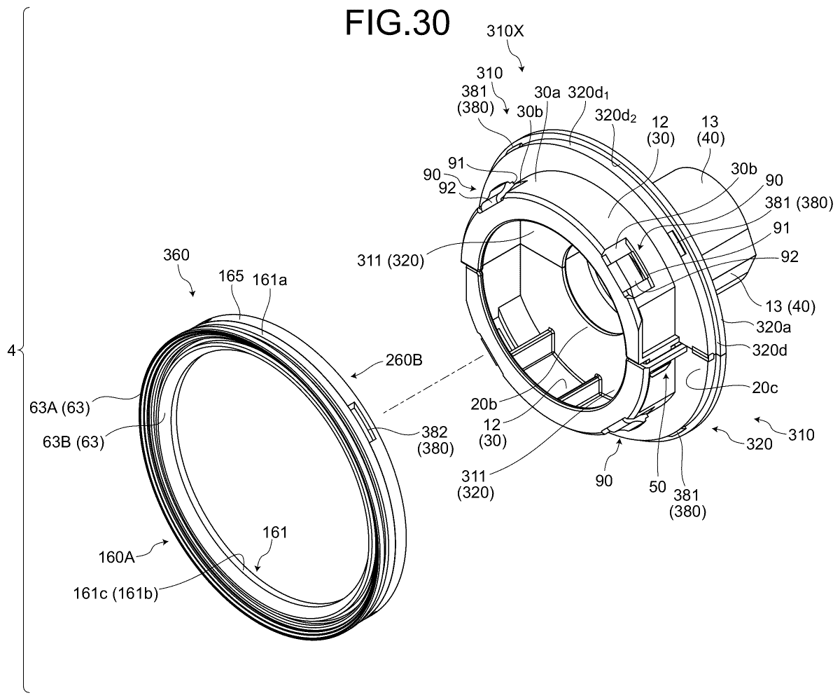

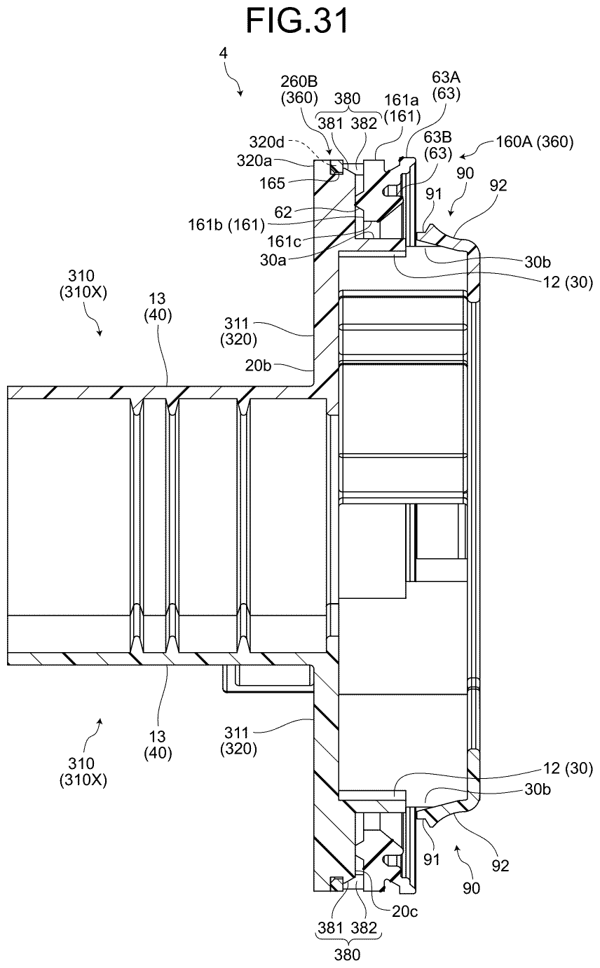

A grommet 4 of the present modification example includes a base member 310X (base members 310 and 310 assembled to each other) and a grommet main body 360 (FIGS. 30 and 31). In addition, the grommet 4 includes an engagement mechanism 380 that engages a first engagement portion 381 provided in the base member 310X (base members 310 and 310 assembled to each other) and a second engagement portion 382 provided in the grommet main body 360, and holds the base member 310X (base members 310 and 310 assembled to each other) and the grommet main body 360 at the assembly completion position, between the base member 310X (base members 310 and 310 assembled to each other) and the grommet main body 360 (FIGS. 30 and 31).

The base member 310X (base members 310 and 310 assembled to each other) is obtained by applying the modifications (to be described below) in the base member 210X (base members 210 and 210 assembled to each other) of the above-described second modification example. The grommet main body 360 illustrated here is configured as similar to the grommet main body 260 of the above-described second modification example, and includes the waterproof member 160A and the support member 260B. Therefore, the same reference numerals as those in the embodiment or first and second modification examples denote the same components, parts, and the like as those in the embodiment or first and second modification examples also in the description of the present modification example.

The base member 310X of the present modification example corresponds to the base member 210X of the second modification example in which the flange 220 is replaced with a flange 320 (FIGS. 30 to 32). The flange 320 corresponds to the flange 220 of the second modification example in which an annular gap between the first flange portion 121 and the second flange portion 122 is filled, and has a shape similar to that of the flange 20 of the embodiment. Accordingly, each of the two base members 310 and 310 includes a divided flange 311 that combines the joint surfaces 10a to each other to form the flange 320 (FIGS. 30 to 32).

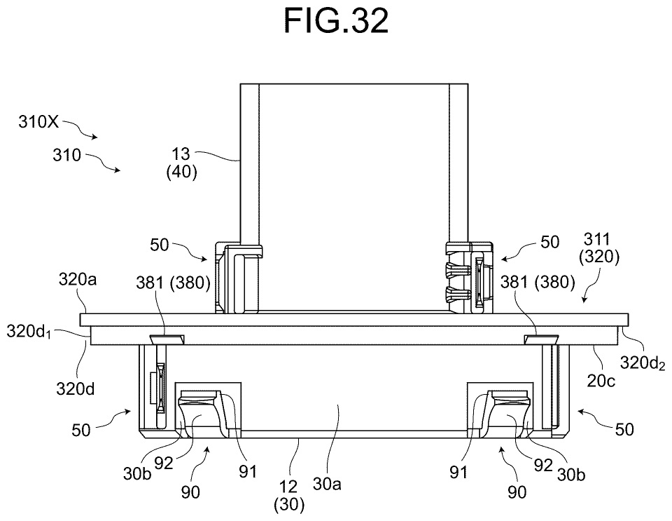

Similarly to the flange 20 of the embodiment, the flange 320 includes an annular fitting portion 320d in which the annular portion 165 of the support member 260B is coaxially fitted in the outer peripheral edge portion 320a (FIGS. 30 to 32). The fitting portion 320d includes: a first wall surface 320d₁ disposed to face the inner peripheral surface of the annular portion 165; and a second wall surface 320d₂ disposed to face the annular end surface on the protruding direction side of the annular portion 165 (FIGS. 30 and 32). In the flange 320, the first engagement portion 381 having a projection shape in the engagement mechanism 380 is provided on the first wall surface 320d₁ (FIGS. 30 and 32). The first engagement portion 381 is formed in a claw-like projection shape. The first wall surface 320d₁ is provided with four first engagement portions 381 at equal intervals around the axis of the cylinder axis of the base member 310X.

Similarly to the second engagement portion 282 of the second modification example, four second engagement portions 382 of the engagement mechanism 380 are provided in the annular portion 165 of the support member 260B as hollow shapes of through-hole shapes at equal intervals around the axis thereof (FIGS. 30 and 31).

In the engagement mechanism 380 of the present modification example, when the base member 310X (base members 310 and 310 assembled to each other) and the grommet main body 360 are assembled and reach the assembly completion position, the first engagement portion 381 is inserted into the second engagement portion 382 of the grommet main body 360 from the opening. The first engagement portion 381 is locked to the annular portion 165 of the support member 260B at the second engagement portion 382. As a result, in the grommet 4, the base member 310X (base members 310 and 310 assembled to each other) and the grommet main body 360 are maintained at the assembly completion position.

Here, in the support member 260B of the present modification example, the first lip 62 is disposed in a disk-shaped space surrounded by the annular portion 165, similarly to the support member 260B of the second modification example. Therefore, the flange 320 has a function as a lid that closes the disk-shaped space of the support member 260B at the assembly completion position. In the grommet main body 360, in a state where the annular portion 165 is fitted into the fitting portion 320d of the outer peripheral edge portion 320a of the flange 320, similarly to the grommet main body 260 of the second modification example, the outer diameter of the outer peripheral edge portion 320a in the flange 320 and the outer diameter of the annular portion 165 are the same, and water is less likely to be splashed into the gap between the second wall surface 320d₂ and the annular portion 165. Therefore, in the grommet main body 360, it is possible to prevent water from entering the disk-shaped space of the support member 260B from the gap, and even when water enters the disk-shaped space of the support member 260B from the gap, the water can be stopped by the first lip 62.

In the grommet main body 360, similarly to the grommet main body 260 of the second modification example, the waterproof member 160A and the support member 260B are formed by the first mold 621, the second mold 622, and the third mold 623. Therefore, in the waterproof member 160A, the load applied from the first mold 621 can be reduced when the first mold 621 is removed in the removal direction M1. In addition, in the waterproof member 160A, the load applied from the second mold 622 can be reduced when the second mold 622 is removed in the removal direction M2. In addition, in the waterproof member 160A, the load applied from the third mold 623 can also be reduced when the third mold 623 is removed in the removal direction M3.

As described above, in the grommet 4 of the present modification example, similarly to the grommet 3 of the second modification example, the engagement mechanism 380 is provided between the base member 310X (base members 310 and 310 assembled to each other) made of hard resin and the support member 260B, and it is possible to ensure the holding force between the base member 310X (base members 310 and 310 assembled to each other) and the grommet main body 360. In the grommet main body 360 of the present modification example, the first mold 621, the second mold 622, and the third mold 623 can be removed in the removal directions M1, M2, and M3, respectively, while reducing the load applied to the waterproof member 160A from the first mold 621, the second mold 622, and the third mold 623. Therefore, in the grommet 4 of the present modification example, the grommet main body 360 in which deterioration in quality of the waterproof member 160A is suppressed is provided.

In the grommet according to the present embodiment, the engagement mechanism is provided between the base member and the support member made of hard resin, and the holding force between the base member and the grommet main body can be ensured.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

1. A grommet comprising:
a cylindrical base member which is made of a hard synthetic resin material, and internally inserts a conductive wiring member that passes from one space to the other space through a through-hole of an insertion object; and
an annular grommet main body which is coaxially assembled to the base member and is disposed in the one space at an attachment completion position on the peripheral edge portion of the through-hole of the insertion object, wherein
the base member includes an annular flange which is disposed in the one space at the attachment completion position and in which an outer peripheral edge portion is disposed to face the annular peripheral edge portion coaxially with a gap, and a cylindrical body that protrudes coaxially from the flange toward the other space and is inserted into the through-hole at the attachment completion position,
the grommet main body is a molded article formed by integrally molding an annular waterproof member made of an elastically deformable synthetic resin material softer than the base member, and coaxially brought into close contact with the outer peripheral edge portion of the flange at an assembly completion position with the base member and coaxially brought into close contact with the peripheral edge portion at the attachment completion position, and an annular support member made of a synthetic resin material harder than the waterproof member,
a plurality of engagement mechanisms for engaging a first engagement portion provided in the base member with a second engagement portion provided in the support member and holding the base member and the grommet main body at the assembly completion position are provided around an axis of a cylinder axis of the base member, between the base member and the support member, and
one of the first engagement portion and the second engagement portion is formed as a hollow shape opened in a direction orthogonal to the cylinder axis, and the other of the first engagement portion and the second engagement portion is formed as a projection shape inserted into the hollow shape from an opening in the orthogonal direction.

2. The grommet according to claim 1, wherein
the waterproof member includes an annular main body that is disposed to face the outer peripheral edge portion of the flange coaxially with a gap at the assembly completion position and is disposed to face the peripheral edge portion coaxially with a gap at the attachment completion position, an annular first lip that protrudes coaxially from the main body, is elastically deformed at the assembly completion position, and is brought into close contact with the outer peripheral edge portion of the flange over an entire periphery, and an annular second lip that protrudes coaxially from the main body, is elastically deformed at the attachment completion position, and is brought into close contact with the peripheral edge portion over the entire periphery.

3. The grommet according to claim 2, wherein
the support member includes an annular portion disposed to face the outer peripheral edge portion of the flange coaxially with a gap at the assembly completion position,
the main body coaxially integrates the annular portion in a form of being fitted into an annular groove having an inner peripheral surface side as a groove bottom and each of the flange side and the peripheral edge portion side as a groove side wall,
the cylindrical body is formed with the first engagement portion having the opening disposed to face the inner peripheral surface of the main body, and
the second engagement portion is formed as a projection shape protruding from an inner peripheral surface of the annular portion and extending from the inner peripheral surface of the main body.

4. The grommet according to claim 2, wherein
the support member includes a first annular portion disposed to face the outer peripheral edge portion of the flange coaxially with a gap at the assembly completion position, and a second annular portion protruding coaxially from an outer peripheral edge portion of the first annular portion toward the outer peripheral edge portion of the flange,
the outer peripheral edge portion of the flange includes an annular fitting portion into which the second annular portion is coaxially fitted,
the fitting portion includes a first wall surface disposed to face an inner peripheral surface of the second annular portion, and a second wall surface disposed to face the annular end surface on the protruding direction side of the second annular portion,
the main body coaxially integrates the first annular portion in a form of being fitted into an annular groove having an inner peripheral surface side as a groove bottom and each of the flange side and the peripheral edge portion side as a groove side wall,
the cylindrical body is formed with the first engagement portion having the opening disposed to face the inner peripheral surface of the main body, and
the second engagement portion is formed as a projection shape protruding from an inner peripheral surface of the first annular portion and extending from the inner peripheral surface of the main body.

5. The grommet according to claim 2, wherein
the first engagement portion having the opening is formed in the outer peripheral edge portion of the flange,
the support member includes an annular portion integrated with an annular joint portion at an outer peripheral edge portion of the main body and coaxially protruding from the joint portion toward the outer peripheral edge portion of the flange,
an inner peripheral surface of the annular portion is disposed to face the opening, and
the second engagement portion is formed as a projection shape protruding from the inner peripheral surface of the annular portion.

6. The grommet according to claim 2, wherein
the support member includes an annular portion integrated with an annular joint portion at an outer peripheral edge portion of the main body and coaxially protruding from the joint portion toward the outer peripheral edge portion of the flange,
the annular portion includes the second engagement portion having a hollow shape in which the opening is provided on an inner peripheral surface of the annular portion, and
the outer peripheral edge portion of the flange includes the first engagement portion formed in a projection shape.
